(19) United States
(12) Patent Application Publication
(10) Pub. No.: US 2015/0298451 A1
(43) Pub. Date: Oct. 22, 2015

(54) GRAPHIC ARTS SLEEVE AND SUPPORT MANDREL

(71) Applicant: Universal Engraving, Inc., Overland Park, KS (US)

(72) Inventors: Larry R. Hutchison, Overland Park, KS (US); Eric A. Domsch, Olathe, KS (US)

(73) Assignee: Universal Engraving, Inc., Overland Park, KS (US)

(21) Appl. No.: 14/689,935

(22) Filed: Apr. 17, 2015

Related U.S. Application Data
(60) Provisional application No. 61/981,053, filed on Apr. 17, 2014.
(60) Provisional application No. 62/135,022, filed on Mar. 18, 2015.

(51) Int. Cl. B41C 1/18; B23K 26/28; B23K 31/02; B23K 26/30; B23K 26/00; B41C 1/02; C25D 7/04

(52) U.S. Cl. CPC B41C 1/182; B41C 1/02; B23K 26/285; C25D 7/04; B23K 26/421; B23K 26/0093; B23K 31/027

(57) ABSTRACT

A graphic arts sleeve includes a multilayer curved plate and an elongated slide. The plate presents opposed end margins that cooperatively form a longitudinal seam. The plate includes an engravable layer and an inner layer cladded relative to one another, with the inner layer being located radially inward of the engravable layer. The slide extends along the seam and is fixed relative to the plate radially inward of the engravable layer. A filler is located at least partly within the seam to bridge the end margins of the engravable layer. The engravable layer and the filler cooperatively providing an outer sleeve surface, with at least part of the outer sleeve surface being continuous across the seam from one end margin to the other end margin. A method of fabricating the sleeve and a press mandrel for supporting the sleeve, as well as other types of sleeves, are also disclosed.

### RELATED APPLICATION

This application claims the benefit of U.S. Provisional Application Ser. No. 61/981,053, filed Apr. 17, 2014, entitled ROTOGRAVURE PRINTING SLEEVE AND SUPPORT MANDREL, and U.S. Provisional Application Ser. No. 62/135,022, filed Mar. 18, 2015, entitled GRAPHIC ARTS ROTATING SLEEVE AND SUPPORT MANDREL, each of which is hereby incorporated in its entirety by reference herein.

### BACKGROUND

1. Field

The present invention relates generally to a rotary graphic arts sleeve system. More specifically, embodiments of the present invention concern a multilayer sleeve system suitable for use in rotogravure printing, embossing, debossing, texturing, and/or hot foil stamping. Another embodiment concerns a press mandrel for supporting various types of rotary graphic arts sleeves.

2. Discussion of Prior Art

It is known in the art for a rotary die to be used for graphic arts embossing and/or stamping of a substrate. For instance, conventional graphic arts systems include a solid cylinder mandrel supporting a die plate. It is known for a mandrel to support a bimetal die plate. Prior art systems are also known to include a mandrel with multiple metal die plates.

However, conventional rotary graphic arts systems have certain deficiencies. For instance, the cylinders and dies of known rotary press systems are expensive to build and maintain. Furthermore, conventional rotary press systems are time consuming and expensive to setup. Specifically, conventional systems throughout the industry use setup processes to position dies in precise registration with the substrate.

### SUMMARY

The following brief summary is provided to indicate the nature of the subject matter disclosed herein. While certain aspects of the present invention are described below, the summary is not intended to limit the scope of the present invention.

Embodiments of the present invention provide a graphic arts rotary system that does not suffer from the problems and limitations of the prior art systems set forth above.

A first aspect of the present invention concerns a graphic arts sleeve that broadly includes a multilayer curved plate, an elongated slide, and a filler. The plate presents opposed end margins that cooperatively form a longitudinal seam. The plate includes an engravable layer and an inner layer cladded relative to one another, with the inner layer being located radially inward of the engravable layer. The slide extends along the seam and is fixed relative to the plate radially inward of the engravable layer. The filler is located at least partly within the seam to bridge the end margins of the engravable layer. The engravable layer and the filler cooperatively provide an outer sleeve surface, with at least part of the outer sleeve surface being continuous across the seam from one end margin to the other end margin.

A second aspect of the present invention concerns a method of making a graphic arts sleeve. The method broadly includes the steps of curving a multilayer plate so that end margins thereof are positioned adjacent one another to cooperatively form a longitudinal seam, wherein the plate includes an engravable layer and a radial inner layer cladded relative to one another; fixing the plate to a slide that extends along the seam radially inward of the engravable layer; and filling the seam at least partly with a filler material so that the engravable layer and the filler cooperatively provide an outer sleeve surface that is continuous across the seam from one end margin to the other end margin.

A third aspect of the present invention concerns an expandable press mandrel for removably supporting a graphic arts sleeve during press operations. The mandrel broadly includes a mandrel body having relatively shiftable body sections. The mandrel body presents an outer mounting surface operable to receive the sleeve. The mounting surface defines an outermost dimension of the mandrel body, with relative shifting of the body sections varying the outermost dimension.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a perspective of a rotary graphic arts assembly constructed in accordance with a preferred embodiment of the present invention, with the assembly including a press mandrel and a sleeve;

FIG. 2 is an exploded perspective of the rotary graphic arts assembly shown in FIG. 1, showing end caps, a mandrel body, and screws of the press mandrel;

FIG. 3 is a fragmentary perspective of the graphic arts assembly similar to FIG. 1, but showing clamps attached to each end of the mandrel body, with the clamps holding the mandrel body in a contracted condition to permit mounting of the rotary sleeve;

FIG. 4 is a fragmentary end elevation of the graphic arts assembly shown in FIG. 3, showing the mandrel body in the contracted condition, with the mandrel body defining a slot that intersects an outer receiving surface of the mandrel body and a gap that extends radially inwardly from the slot;

FIG. 4a is an enlarged fragmentary end elevation of the graphic arts assembly shown in FIG. 4, showing the mandrel body in the contracted condition and a slide of the rotary sleeve received in the slot;

FIG. 4b is an enlarged fragmentary end elevation of the graphic arts assembly similar to FIG. 4a, but with the clamps being released so that the mandrel body expands to frictionally engage the rotary sleeve in an engaged condition;

FIG. 5 is a fragmentary perspective of the graphic arts assembly shown in FIGS. 1-4b, showing the mandrel body in the engaged condition;

FIG. 6 is a perspective of a preferred build mandrel for supporting the rotary sleeve during the sleeve fabrication process, particularly illustrating a mandrel body, end caps, screws, and magnets of the build mandrel;

FIG. 7 is an enlarged fragmentary end elevation of a cladded plate which forms part of the rotary sleeve shown in FIGS. 1-5, showing an engravable layer, an inner layer of the plate, with end margins of the plate being machined to remove endmost portions of the engravable layer so as to expose the inner layer;

FIG. 8 is an enlarged fragmentary end elevation of the plate shown in FIG. 7, but depicting the cladded plate formed into a cylindrical shape so that the margins of the machined plate are adjacent to one another and cooperatively form a longitudinal seam;

FIG. 9 is an enlarged fragmentary end elevation of the build mandrel shown in FIG. 6 and the cladded plate shown in FIG. 8, showing the inner layer and the engravable layer of the plate curved onto the build mandrel, and showing a slide mounted in a slot of the build mandrel, with a longitudinal seam of the plate positioned above the slide;

FIG. 10 is an enlarged fragmentary end elevation of the build mandrel and plate similar to FIG. 9, but showing a first longitudinal weld bead being formed to join the end margins of the inner layer to the slide, and showing a second longitudinal weld bead being deposited into and above the seam to join the end margins of the engravable layer;

FIG. 11 is an enlarged fragmentary end elevation of the build mandrel and plate similar to FIG. 10, but with an excess portion of the weld bead being removed so that an outer sleeve surface presents a continuous diameter across the seam, and with a plated layer being applied to the outer sleeve surface;

FIG. 12 is perspective of a rotary graphic arts assembly constructed in accordance with a second preferred embodiment of the present invention, with the assembly including a press mandrel and a sleeve;

FIG. 13 is an exploded perspective of the assembly shown in FIG. 12, showing end caps, screws, and a mandrel body of the press mandrel;

FIG. 14 is an enlarged fragmentary end elevation of the assembly shown in FIGS. 12 and 13, showing a longitudinal slot presented by the mandrel body and a slide of the rotary sleeve positioned in the slot;

FIG. 15 is an enlarged fragmentary end elevation of a cladded plate which forms part of the rotary sleeve shown in FIGS. 12-14, showing an engravable layer, an intermediate carrier layer, and expansion layer of the plate, with end margins of the plate being machined to remove endmost portions of the engravable layer and the expansion layer so as to expose the carrier layer;

FIG. 16 is an enlarged fragmentary end elevation of the plate shown in FIG. 15, but depicting the plate formed into a cylindrical shape so that the margins of the machined plate are adjacent to one another and cooperatively form a longitudinal seam;

FIG. 17 is an enlarged fragmentary end elevation of the curved plate similar to FIG. 16, but with a longitudinal weld being formed along the seam to weld the exposed carrier layer of the curved plate to the slide and thereby form the rotary sleeve;

FIG. 18 is an enlarged fragmentary end elevation of the rotary sleeve similar to FIG. 17, but showing filler material that has been deposited into and above the gap in the engravable layer to form a longitudinal bead;

FIG. 19 is an enlarged fragmentary end elevation of the rotary sleeve similar to FIG. 18, but with an excess portion of the filler bead removed so that the outer surface of the engravable layer presents a continuous diameter across the seam.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

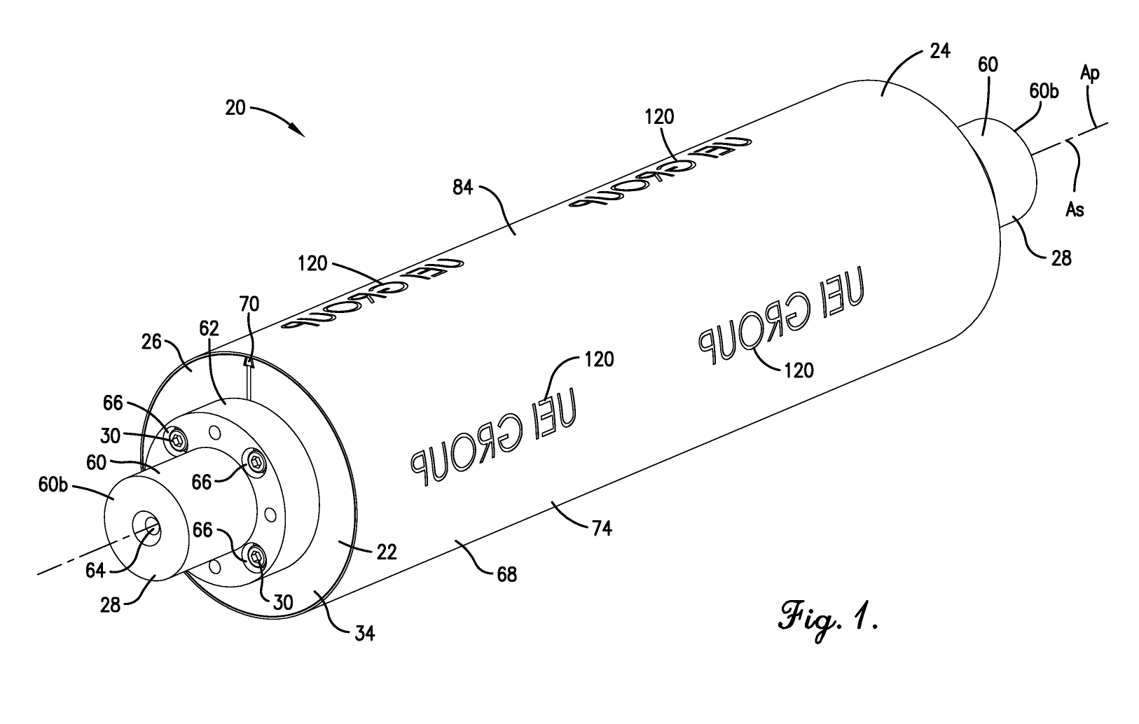

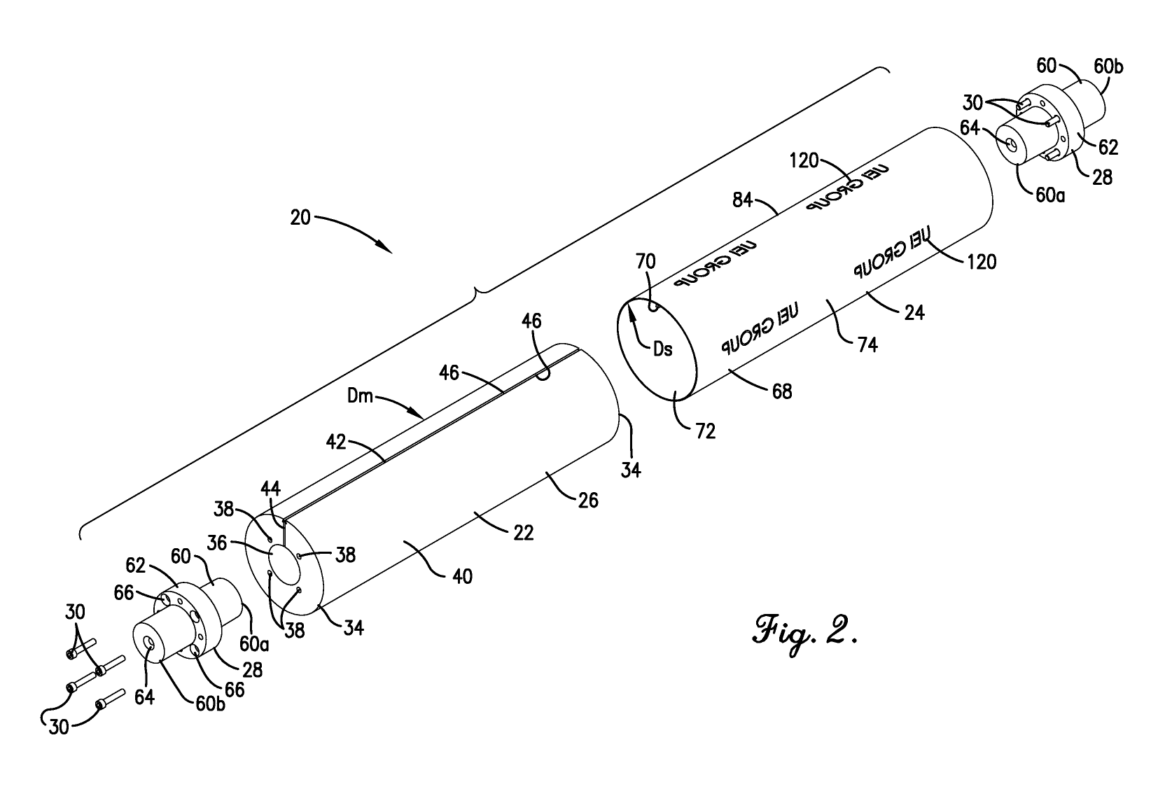

Turning initially to FIGS. 1-2, a graphic arts assembly 20 is constructed in accordance with a preferred embodiment of the present invention. Preferably, the assembly 20 is used with a rotary press (not shown) to provide embossing, debossing, texturing, hot foil stamping, rotogravure printing, or a combination thereof to form a design in a substrate (not shown). In particular regard to the illustrated embodiment, the graphic arts assembly 20 is configured to print on a substrate (not shown) and presents a curved image defined by recessed engraved regions, with the engraved regions corresponding to the printed regions of the substrate. However, the principles of the present invention are applicable where the present invention utilizes a raised image for hot foil stamping.

Again, while the illustrated assembly 20 is used to provide rotogravure printing, the assembly 20 could also or alternatively be used to emboss, deboss, texture, and/or hot foil stamp a substrate. For instance, the engraved regions of the curved image could be used to deboss or texture indicia onto a substrate. However, the design image could alternatively be formed onto an image carrier by removing (e.g., by engraving) material primarily outside the image such that the image is “raised” relative to the remaining part of the image carrier. For example, the image could be “raised” to emboss, texture, or foil stamp indicia onto the substrate. The assembly 20 is particularly suitable for use with narrow web applications where the substrate presents a width of about twenty inches (20″) or less, although other web sizes are within the ambit of certain aspects of the present invention.

Turning to FIGS. 1-5, the graphic arts assembly 20 preferably includes a press mandrel 22 and a rotary sleeve 24. The sleeve 24 is removably mounted to the mandrel 22 during press operation, as will be explained.

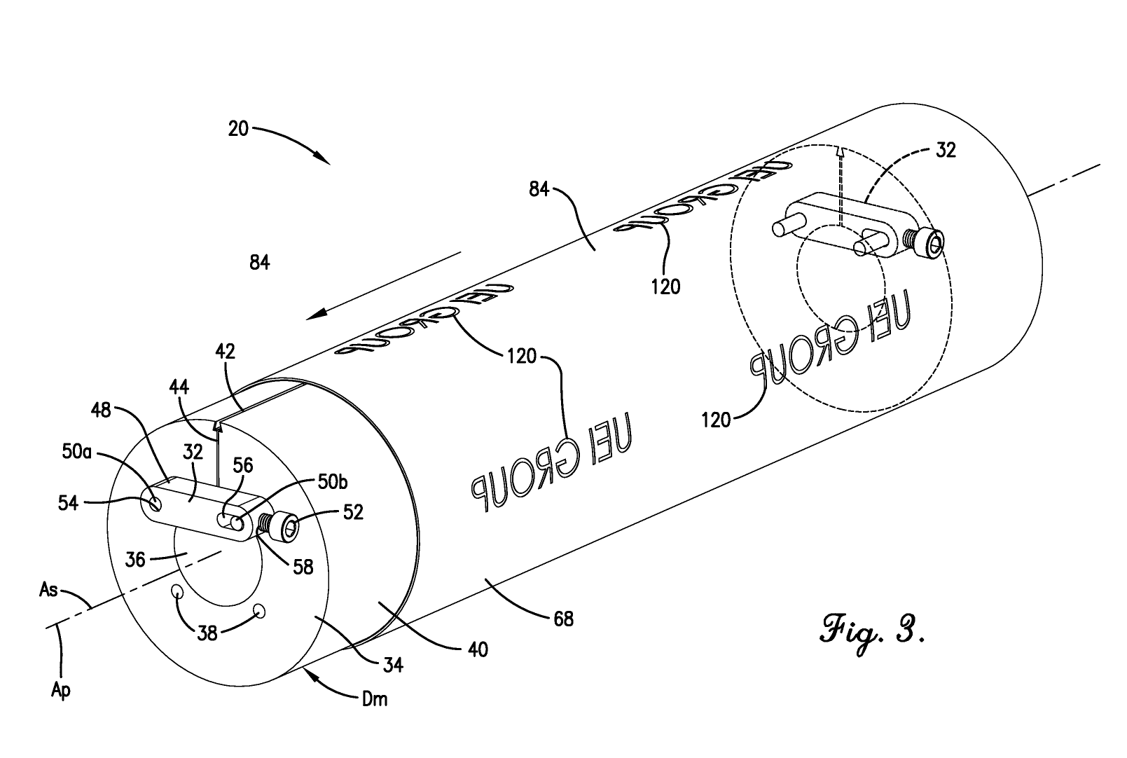

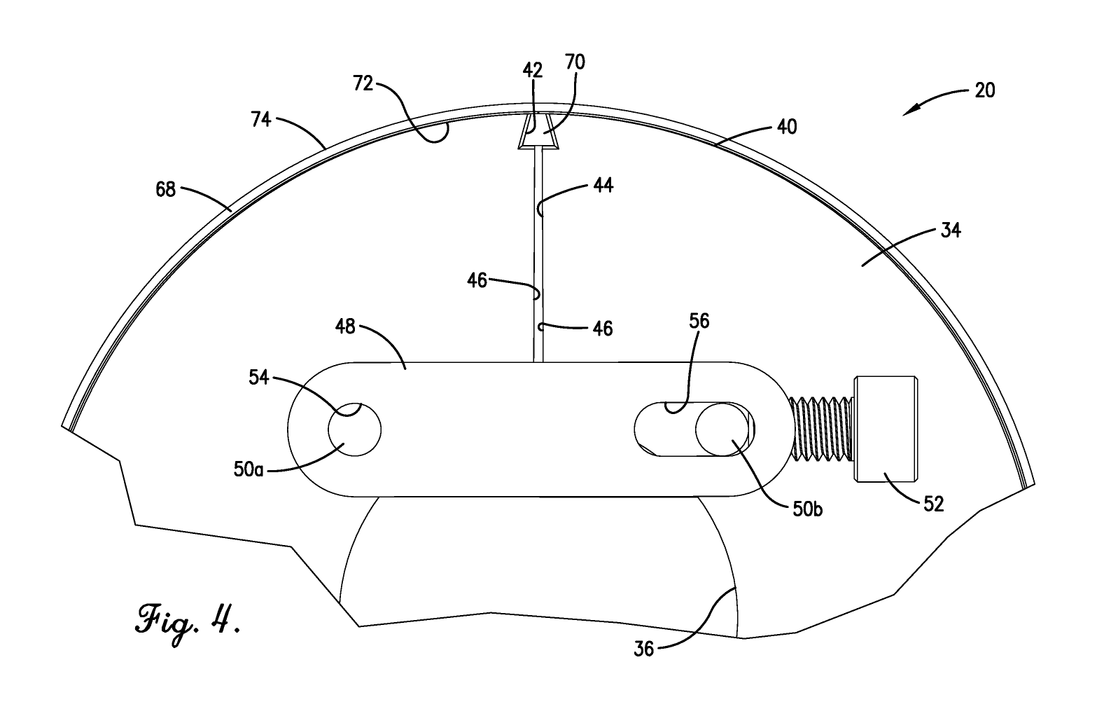

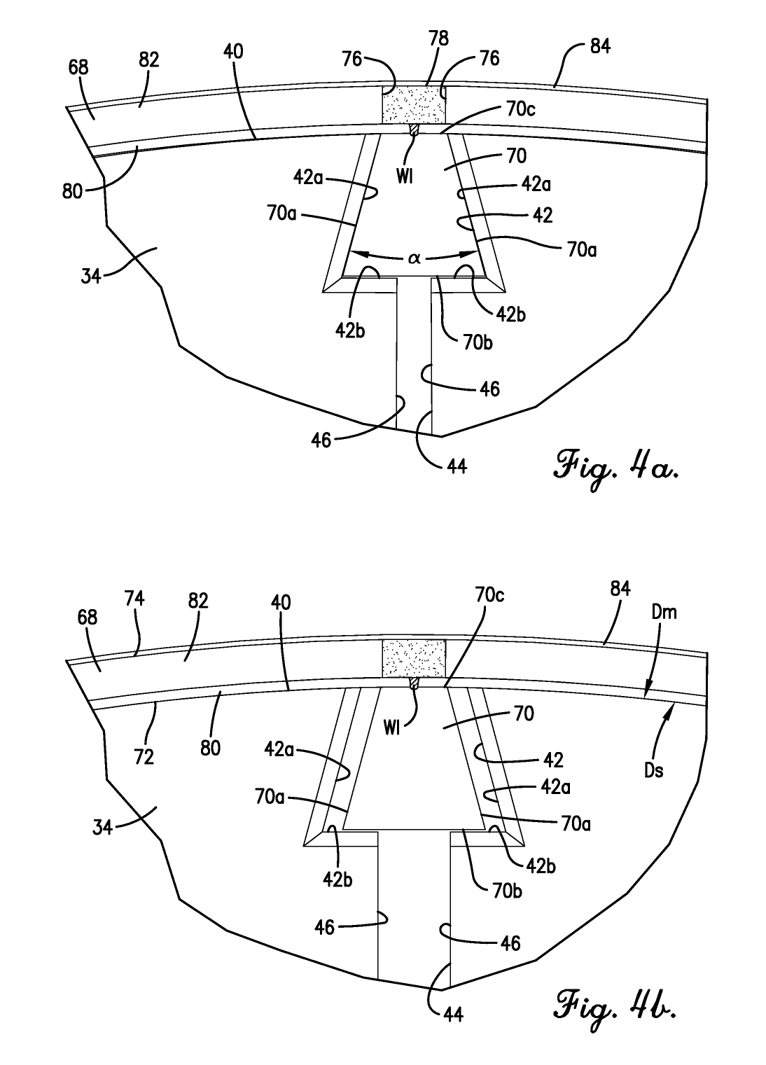

In the illustrated embodiment, the press mandrel 22 preferably includes a mandrel body 26, end caps 28, attachment screws 30, and removable clamps 32 (see FIGS. 3 and 4). The press mandrel 22 is configured to be mounted on a suitable web press (not shown) to support the sleeve 24 thereon.

The mandrel body 26 comprises a generally cylindrical tube and presents opposite tube ends 34 and a cylindrical passage 36 that extends from one end 34 to the other end 34. Each of the ends 34 presents threaded holes 38.

The mandrel body 26 also preferably presents a cylindrical outer receiving surface 40, a slot 42, and a radial gap 44 (see FIG. 4). The outer receiving surface 40 presents an outer mandrel diameter dimension Dm. As will be discussed, the mandrel body 26 is preferably adjustable to change the size of the dimension Dm.

The illustrated slot 42 is defined by opposite side faces 42a and bottom faces 42b presented by the mandrel body 26. The ends of the faces 42a,42b are preferably chamfered (see FIGS. 4a and 4b), for purposes which will be described. The slot 42 extends longitudinally along an axis Ap (see FIG. 3) of the press mandrel 22 and intersects the receiving surface 40. Preferably, the slot 42 presents an axis that is parallel to the axis Ap.

However, it is within the ambit of the present invention where the slot 42 is alternatively configured. For instance, as will be shown in a subsequent embodiment, the slot 42 could be alternatively sized and/or shaped. In some embodiments, a dimension of the slot 42 (e.g., the width and/or height dimension of the slot 42) could taper along the length of the slot 42. Yet further, the slot 42 could present an alternative length. According to certain aspects of the present invention, the mandrel body 26 may alternatively be devoid of the slot 42 or include multiple slots 42 (e.g. where multiple slots 42 are spaced about the circumference of the mandrel body 26 to receive corresponding anti-rotation slides).

The gap 44 is defined by opposed faces 46 of the mandrel body 26. The gap 44 extends longitudinally along the axis Ap of the press mandrel 22. The gap 44 preferably intersects and extends radially outwardly from the passage 36. In the illustrated embodiment, the gap 44 preferably intersects the slot 42, with the gap 44 and the slot 42 cooperatively forming a continuous longitudinal opening that extends from the receiving surface 40 to the passage 36.

However, it is within the scope of the present invention where the gap 44 does not intersect the slot 42. For instance, the gap 44 could be angularly spaced from the slot 42 about the axis Ap so that the gap 44 extends continuously from the passage 36 to the receiving surface 40 without intersecting the slot 42. Furthermore, it will be appreciated that the mandrel body 26 could be devoid of passage 36.

The illustrated faces 46 of the mandrel body 26 are preferably shiftable relative to one another to change the outer mandrel diameter dimension Dm. Specifically, the mandrel body 26 can be flexed between a relaxed condition (see FIG. 2), where no flexing force is applied to the mandrel body 26, and a contracted condition (see FIGS. 3 and 4), where a flexing force is applied to the mandrel body 26 to make the dimension Dm smaller. In the contracted condition, the dimension Dm is preferably smaller than an inner sleeve diameter dimension Ds of the sleeve 24 (see FIG. 4b). In the relaxed condition, the dimension Dm is preferably larger than the dimension Ds of the sleeve 24.

A flexing force is preferably applied to the mandrel body 26 so that the faces 46 are shifted toward each other to reduce the outer mandrel diameter dimension Dm. In this manner, the mandrel body 26 can be flexed from the relaxed condition to the contracted condition. Similarly, the mandrel body 26 resiliently returns to the relaxed condition to shift the faces 46 away from each other to enlarge the outer mandrel diameter dimension Dm. As will be discussed, the mandrel body 26 is operable to slidably receive the sleeve 24 in the contracted condition. When the mandrel body 26 is allowed to shift back toward the relaxed condition, frictional engagement between the sleeve 24 and the mandrel body 26 restricts the sleeve 24 from sliding relative to the mandrel body 26.

It will be appreciated that the mandrel body 26 could be alternatively configured to provide an adjustable outer mandrel diameter dimension Dm. For instance, rather than being a flexible unitary body, the mandrel body may alternatively be formed of multiple discrete sections that are shiftably interconnected. In one such alternative configuration, the body could include annular sections shiftably mounted on a frame (not shown) to provide the adjustable dimension Dm.

It is also within the ambit of the present invention for the body 26 to be contracted when in the relaxed condition. In such an alternative embodiment, the body 26 could be resiliently expanded to securely hold the sleeve 24 thereon. Yet further, the body 26 could be at least partially contracted in the relaxed condition.

As will be discussed, the body 26 is configured to expand from the contracted condition into an engaged condition where the body 26 receives and is in frictional engagement with the sleeve 24. The diameter Dm of the body 26 in the engaged condition is preferably less than the diameter Dm when the body 26 is in the relaxed condition.

The clamps 32 are preferably configured to selectively flex the mandrel body 26 to reduce the outer mandrel diameter dimension Dm. The clamps 32 are preferably substantially the same as one another, although the clamps 32 could be differently constructed. Each clamp 32 preferably includes a clamp body 48, threaded studs 50a,b, and an adjustment screw 52 (see FIGS. 3 and 4). The clamp body 48 is unitary and presents a circular opening 54, a slotted opening 56, and a threaded hole 58. The openings 54,56 are configured to removably receive the studs 50a,b, with the stud 50b being slidable along the length of the slotted opening 56. The studs 50 present threaded ends (not shown) that are removably threaded into corresponding holes 38 in the mandrel body 26. Finally, the screw 52 is operable to be threaded into and out of the threaded hole 58.

Both clamps 32 are preferably used to shift the mandrel body 26 between the relaxed condition and the contracted condition. However, it is within the scope of the present invention where only one clamp 32 is used. To flex the mandrel body 26 toward the contracted condition, the screw 52 is threaded into the hole 58 so that the studs 50 are moved closer to one another. To permit the mandrel body 26 to flex toward the relaxed condition, the screw 52 is threaded out of the hole 58 so that the studs 50 are moved away from one another.

While the illustrated clamps 32 are the preferred means for controlling shifting of the faces 46 of the mandrel body 26, it is within the scope of the present invention where an alternative mechanism is used to selectively control the expansion of the mandrel body 26.

The illustrated end caps 28 serve to support the mandrel body 26. Each end cap 28 includes a cylindrical tube 60 and a flange 62 that projects radially outwardly from the tube 60. The tube 60 presents inner and outer ends 60a,60b and a bore 64 that extends longitudinally through the tube 60 (see FIGS. 2 and 3). However, it is also within the scope of the present invention where tube 60 does not include the bore 64 (i.e., where the tube 60 is replaced with a solid cylinder). The illustrated tube 60 presents an outer diameter that is continuous along the length of the tube 60. However, the outer surface of tube 60 could be sized and tapered toward the inner end 60a so that insertion of the inner end 60a into the passage 36 causes the mandrel body 26 to expand from the relaxed condition. The flange 62 is spaced between the ends 60a,60b and presents counterbore holes 66 that extend through the flange 62 and are positioned about the tube 60. Although the end caps 28 are substantially the same, it is within the scope of the present invention where the end caps 28 are shaped differently from one another.

Each end cap 28 is removably inserted into a corresponding tube end 34 of the mandrel body 26 so that the inner end 60a of end cap 28 is positioned within the passage 36. The end cap 28 is inserted into the passage 36 until the flange 62 contacts the corresponding tube end 34. Each end cap 28 is secured to the mandrel body 26 with screws 30 that are inserted through the holes 66 and threaded into corresponding threaded holes 38. In the usual manner, the press mandrel 22 is operable to be rotatably mounted on the rotary press so that the press mandrel 22 spins about the mandrel axis Ap.

The end caps 28 are preferably configured to be attached to the mandrel body 26 when the body 26 is expanded into the engaged condition. Specifically, when the body 26 is in the engaged condition, the holes 66 of the end caps 28 are preferably in registration with corresponding ones of the threaded holes 38. However, if necessary, the holes 66 can be oversized and/or slotted to accommodate for the expanded condition of the mandrel body 26. It will be appreciated that the mandrel body 26 could expand to various degrees to engage the sleeve 24 (e.g., depending on the size of the sleeve 24).

The end caps 28 are preferably used to support the mandrel body 26 in the engaged condition during operation of the press. However, the tube 60 could be sized and tapered so that insertion of the inner end 60a into the passage 36 causes the end caps 28 to apply an expansion force against the mandrel body 26 in the engaged condition. That is, the end caps 28 could be configured to urge the mandrel body 26 radially outwardly into engagement with the sleeve 24. It is also within the scope of the present invention where the press mandrel 22 does not include end caps 28 (e.g., when the press mandrel 22 is used for hot foil stamping).

The mandrel body 26, end caps 28, and clamps 32 each preferably include a hardened steel material. The mandrel body 26, end caps 28, and clamps 32 may be formed entirely (or even partly) of hardened steel. However, the mandrel body 26, end caps 28, and/or clamps 32 could include other metal materials, such as alloy steel or stainless steel.

Again, the illustrated press mandrel 22 is used to frictionally engage and support the bimetal sleeve 24. However, it is within the ambit of the present invention for the press mandrel 22 to receive and support alternatively constructed sleeve-type die assemblies. For example, the press mandrel 22 is capable of being used with a single layer graphic arts rotary sleeve or a multilayer graphic arts rotary sleeve constructed differently than the embodiments disclosed herein. As a further example, the press mandrel 22 could alternatively be used to support a multilayer sleeve where one or more layers of the sleeve are provided by a thermal spray process and/or an electroplating process.

Turning to FIGS. 1-11, the sleeve 24 preferably includes a curved plate 68 and an elongated slide 70 that cooperatively present a unitary sleeve construction. The sleeve 24 preferably presents inner and outer sleeve surfaces 72,74.

The curved plate 68 is preferably unitary and is curved about a sleeve axis As to assume a generally cylindrical tube shape where opposed end margins 76 are positioned adjacent one another (see FIG. 8). While the curved plate 68 is capable of being flexed out of this position, the curved plate 68 generally maintains the cylindrical tube shape in the absence of external forces (such as flexing forces). The inner sleeve surface 72 defines the inner sleeve diameter dimension Ds (see FIGS. 4b and 8). Preferably, the end margins 76 are positioned adjacent one another and cooperatively form a longitudinal seam 78 that extends along the length of the curved plate 68 (see FIGS. 4a and 8). As will be discussed, the illustrated end margins 76 are fixed relative to one another, and the seam 78 is suitably filled so that the outer surface 74 is smooth and continuous.

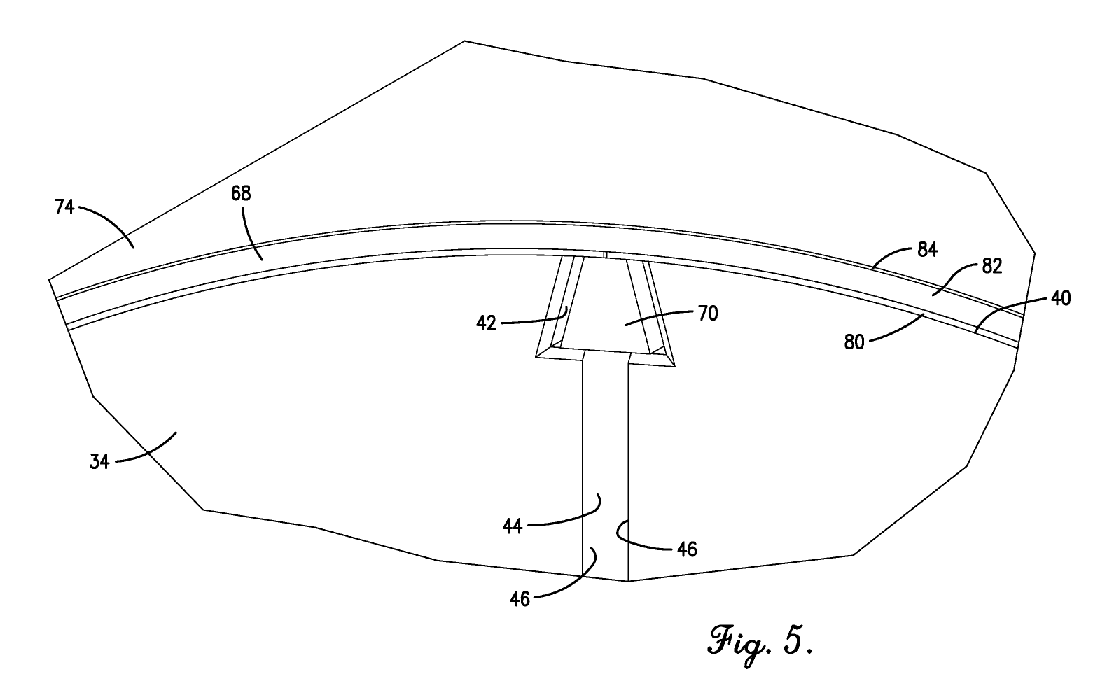

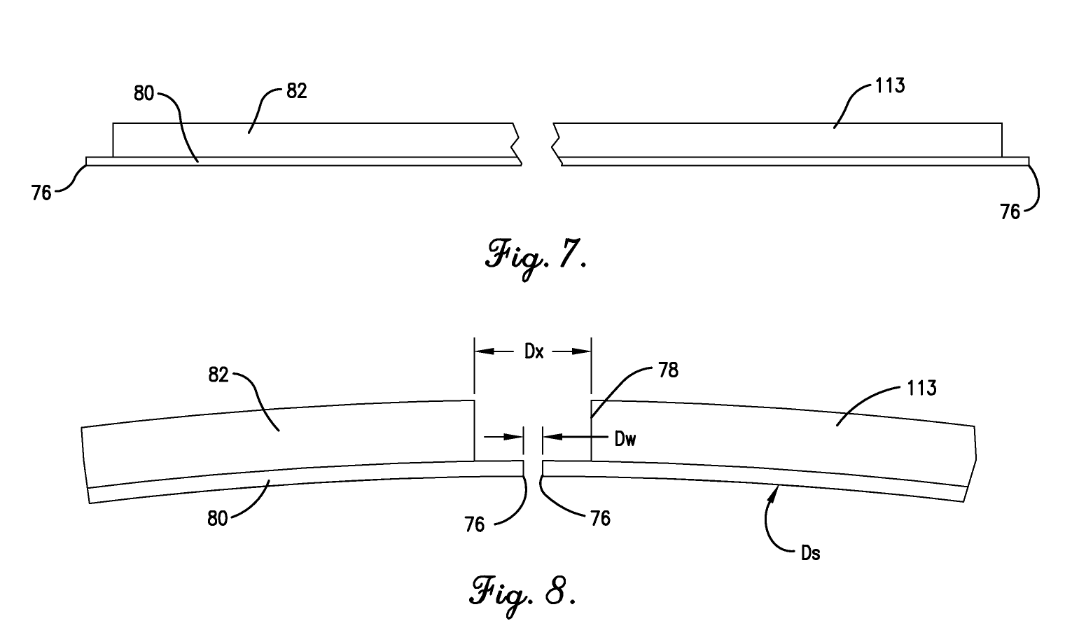

The curved plate 68 is preferably formed of a multilayer material, although certain aspects of the present invention contemplate the use of a solid, single layer plate. In the illustrated embodiment, the plate 68 is formed of a bimetal material, including an inner carrier layer 80 and an overlying engravable layer 82. The layers 80,82 are preferably cladded to one another (see FIG. 7). Preferably, the layers 80,82 are initially provided separately in the form of flat sheets (not shown). The flat sheets are then preferably cladded to one another to form a cladded flat plate (not shown). As will be discussed, the sleeve 24 also includes an outermost plated layer 84 (see FIG. 5), which is applied to the curved plate 68 after the image is formed on the curved plate 68. In this particular embodiment, the inner layer 80 presents the inner sleeve surface 72 and the plated layer 84 presents the outer sleeve surface 74.

In the disclosed embodiment, the layers 80,82,84 each include a metal material. The engravable layer 82 is preferably cladded to the inner layer 80 using conventional cladding techniques. The plated layer 84 is applied to the engravable layer 82 using a conventional plating process.

Preferably, the inner layer 80 comprises a steel alloy material that is magnetic. However, the inner layer 80 could include an alternative metal, such as stainless steel. As used herein, the term “magnetic” refers generally to ferrous materials that are either magnetized or capable of being magnetized.

The engravable layer 82 preferably includes copper. However, it is within the ambit of the present invention where the engravable layer 82 includes one or more other metals suitable for engraving (e.g., magnesium, bronze, etc.). While the copper material of the engravable layer 82 is generally softer than the inner layer 80, it will be appreciated that the engravable layer 82 could include a material that is harder than the inner layer 80 (e.g., to provide improved wear resistance).

The plated layer 84 preferably includes a nickel or chrome material, but could include an alternative material for suitably protecting the engraved surface of the engravable layer 82. The plated layer 84 is preferably applied to the engravable layer 82 after the layer 82 is engraved.

The illustrated slide 70 comprises a unitary rod that presents side surfaces 70a, a bottom surface 70b, and a top surface 70c (see FIGS. 4a and 4b). The surfaces 70a,70b,70c preferably give the slide 70 a cross-sectional shape in the form of a dovetail. The side surfaces 70a are each preferably planar. In the illustrated embodiment, the side surfaces 70a converge in a direction toward the top surface 70c and cooperatively define the angle α (see FIG. 4a). The angle α is preferably an acute angle and, more preferably, ranges from about twenty degrees) (20°) to about forty degrees (40°) and, more preferably, is about thirty degrees (30°). The bottom surface 70b is also preferably planar and extends at an acute angle to the side surfaces 70a. However, as will be shown in a subsequent embodiment, the slide 70 could have an alternative cross-sectional shape.

The top surface 70c of slide 70 is preferably planar. Because the inner sleeve surface 72 is curved, the top surface 70c is positioned either immediately adjacent to or is in at least partial engagement with the inner sleeve surface 72 along the end margins 76. However, the slide 70 and curved plate 68 could be alternatively configured to provide conforming engagement. For instance, the inner sleeve surface 72 could include flat surface sections along the margins 76 that engage the top surface 70c of the slide 70. The top surface 70c could also have a convex shape (e.g., where the top surface 70c presents the same radius as the inner sleeve surface 72).

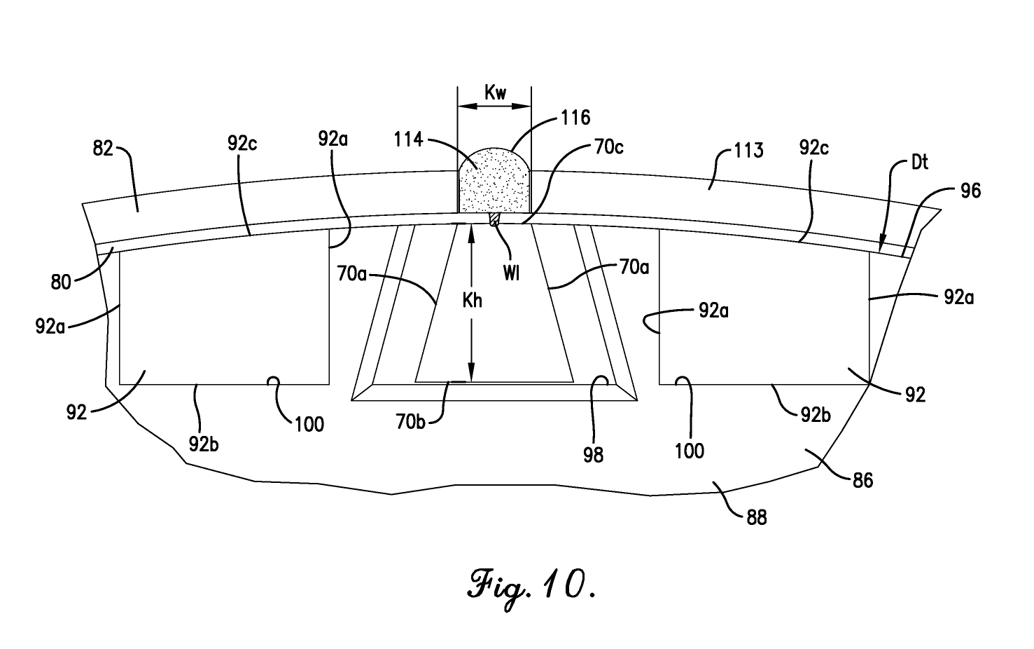

The slide 70 preferably presents a height dimension Kh and an upper width dimension Kw (see FIG. 10). The dimension Kh preferably ranges from about one hundred thousandths of an inch (0.100″) to about two hundred fifty thousandths of an inch (0.250″). The dimension Kw preferably ranges from about fifty thousandths of an inch (0.050″) to about one hundred fifty thousandths of an inch (0.150″). The slide 70 preferably includes an alloy steel material, but could include other materials. Also, the material of the illustrated slide 70 preferably matches the material of the inner layer 80. However, it is within the ambit of the present invention where the slide 70 and the inner layer 80 are made of dissimilar materials. However, even if the slide 70 and inner layer 80 have different materials, these components could still be fixed to one another (e.g., by welding).

The illustrated slide 70 is preferably located entirely radially inwardly relative to the inner sleeve surface 72. In this manner, the slide 70 is located to engage the slot 42 of the press mandrel 22 to restrict relative rotation between the press mandrel 22 and the sleeve 24. However, for some aspects of the present invention, the slide 70 could be alternatively radially positioned relative to the layers 80,82. For instance, the top surface 70c could be positioned radially outwardly from the inner sleeve surface 72 (but spaced radially inward from the outer sleeve surface 74). Also, the bottom surface 70b of the slide 70 could be substantially flush with the inner sleeve surface 72 or spaced radially outwardly from the inner sleeve surface 72 (e.g., where the frictional engagement between the press mandrel 22 and the sleeve 24 is sufficient to restrict relative rotation therebetween.

As will be discussed, the slot 42 and the slide 70 are operable to be aligned so that the sleeve 24 can be moved axially onto the mandrel body 26, with one end of the slide 70 being inserted into the slot 42. The slide 70 and slot 42 are preferably complementally sized and shaped to permit axial insertion and removal of the slide 70 relative to the slot 42. Furthermore, the slot 42 and the slide 70 preferably engage one another when the sleeve 24 is mounted on the press mandrel 22. It has been found that the interengagement between the slot 42 and the slide 70 restricts relative rotation between the press mandrel 22 and the sleeve 24. The tapered cross-sectional shape of the slot 42 and the slide 70 also restrict radial separation of the press mandrel 22 and the sleeve 24 along the slot 42 (e.g., due to centrifugal forces). Furthermore, in the event that the slide 70 becomes partly (or entirely) detached from the rest of the sleeve 24. The complemental shapes of the slot 42 and the slide 70 cooperate to retain the slide 70 within the slot 42.

However, for some aspects of the present invention, the slide 70 could be alternatively configured. For instance, the slide 70 could be alternatively sized and/or shaped. In some embodiments, a dimension of the slide 70 (e.g., the width and/or height dimension of the slide 70) could taper along the length of the slide 70. Also, the width and/or height dimension of the slide 70 could have an alternative dimension. Yet further, the slide 70 could present an alternative length.

Similar to the illustrated embodiment, an alternative slide configuration is preferably used in connection with a slot that is complementally shaped and sized. That is, the slot and the slide preferably have complemental shapes and sizes (e.g., to provide secure engagement between the sleeve 24 and the mandrel body 26). It will also be appreciated that the assembly 20 could be devoid of the slide 70 or could include multiple slides 70 (e.g. where multiple slides 70 are spaced along the circumference of the curved plate 68).

The curved plate 68 and slide 70 are welded to one another so that the sleeve 24 has a unitary construction and presents the inner sleeve diameter dimension Ds. Furthermore, the sleeve 24 is preferably constructed to be mounted on and in frictional engagement with the press mandrel 22. That is, the sleeve 24 is sized so that the inner sleeve diameter dimension Ds is equal to or undersized relative to the outer mandrel diameter dimension Dm when the mandrel body 26 is in the relaxed condition. Preferably, with the mandrel body 26 in the relaxed condition, the difference of the outer mandrel diameter dimension Dm minus the inner sleeve diameter dimension Ds (Dm−Ds) preferably ranges from about zero inches (0.0000″) to about fifteen ten-thousandths of an inch (0.0015″).

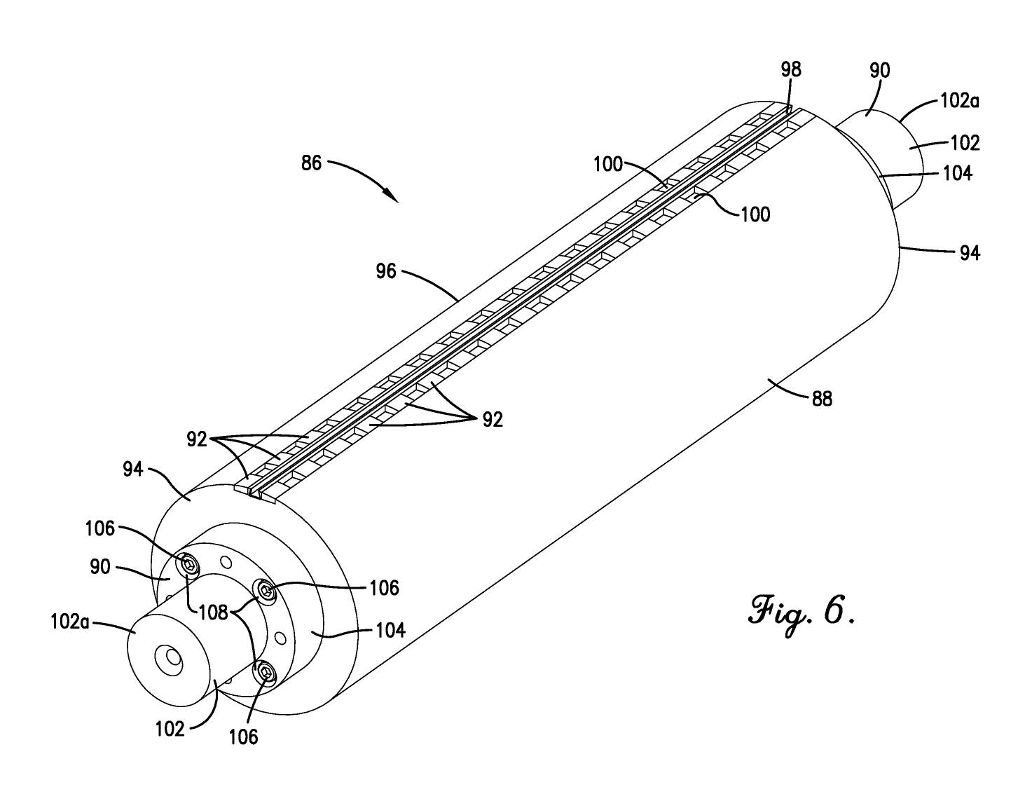

Turning to FIGS. 6-11, a build mandrel 86 is preferably used to manufacture the sleeve 24. As will be discussed, the build mandrel 86 is preferably used to hold the curved plate 68 and slide 70 while sleeve 24 and slide 70 are interconnected and as filler material is deposited within the seam 78. The build mandrel 86 is also preferably used to hold the sleeve components as excess filler material is removed from the sleeve 24. However, it is within the scope of the present invention where the sleeve is positioned on multiple build mandrels for different steps of the fabrication process. The build mandrel 86 cooperates with the sleeve 24 and the press mandrel 22 to provide a graphic arts rotary system to fabricate and use rotary sleeves 24.

The build mandrel 86 preferably includes a build mandrel body 88, end caps 90, and elongated magnets 92. As will be discussed, the build mandrel 86 preferably includes a plurality of magnets 92 to precisely hold the curved plate 68 on the build mandrel 86. The mandrel body 88 comprises a generally cylindrical tube having opposite tube ends 94. A cylindrical passage (not shown), similar to passage 36 on the press mandrel 22, extends from one end 94 to the other end 94. Each of the ends 94 presents threaded holes (not shown) similar to threaded holes 38 on the press mandrel 22.

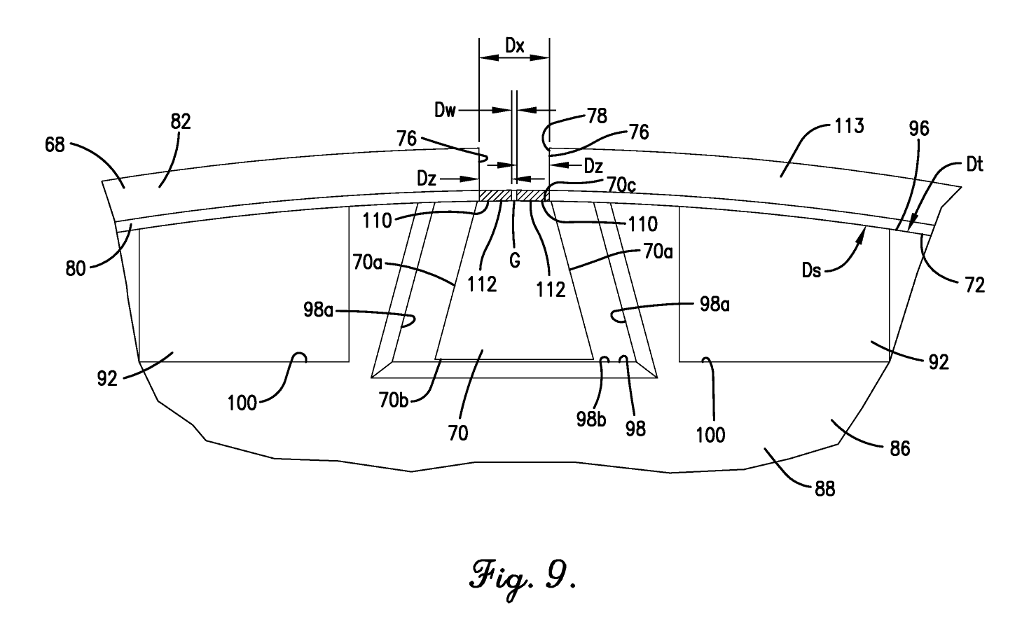

The build mandrel body 88 also preferably presents a cylindrical outer receiving surface 96, a slot 98, and longitudinal channels 100 (see FIGS. 6 and 9) located on opposite sides of the slot 98. The receiving surface 96 presents an outer build mandrel diameter dimension Dt. The dimension Dt of the build mandrel body 88 is preferably slightly undersized relative to the dimension Dm of the press mandrel 22 in the relaxed condition.

The build mandrel body 88 includes opposite side faces 98a and a bottom face 98b which define the slot 98 (see FIG. 9). The slot 98 extends longitudinally along the axis of the build mandrel body 88 and intersects the receiving surface 96. The illustrated slot 98 is formed by cutting a channel shape in the build mandrel body 88 between the channels 100. However, as will be discussed, the slot 98 could be alternatively formed as part of the build mandrel 86.

The slide 70 and slot 98 are preferably complementally sized and shaped to permit insertion and removal of the slide 70 relative to the slot 98. The slot 98 is also preferably shaped to position the slide 70 during fabrication of the sleeve 24. The height dimension of the slide 70 is preferably about the same as the height dimension of the slot 98. However, the width dimension of the slot 98 is preferably oversized relative to the width dimension of the slide 70. Consequently, the slide 70 fits loosely within the slot 98.

It will be appreciated that any alternative slide configuration is preferably used in connection with a slot that is complementally shaped and sized. Therefore, in the event that the slide configuration is changed, the slot configuration is changed so that the slot and the slide have complemental shapes and sizes. Similarly, if the slot configuration is changed, the slide configuration is also preferably changed to produce complemental shapes and sizes.

For instance, a dimension of the slot 98 (e.g., the width and/or height dimension of the slot 98) could taper along the length of the slot 98. Also, the slot 98 could have an alternative cross-sectional shape. Yet further, the slot 98 could present an alternative length.

The principles of the present invention are also applicable where the mandrel body 88 is devoid of the slot 98 or includes multiple slots 98 (e.g. where multiple slots 98 are spaced about the circumference of the mandrel body 88 to receive corresponding slides).

Each end cap 90 is similar to end caps 28 and preferably includes a tube 102 and a flange 104, with the tube 102 presenting an inner end (not shown) and an outer end 102a (see FIG. 6). Each end cap 90 is removably inserted into a corresponding tube end 94 of the mandrel body 88 so that the inner end is positioned within the passage 80. The end cap 90 is inserted into the passage of the mandrel body 88 until the flange 104 contacts the corresponding tube end 94. Each end cap 90 is secured to the mandrel body 88 with screws 106 that are inserted through holes 108 in the flange 104 and threaded into corresponding threaded holes (not shown) in the mandrel body 88. While the end caps 90 are preferred, it is within the ambit of the present invention where the build mandrel body 88 is used without end caps 90.

The mandrel body 88 preferably includes an anodized aluminum alloy material. However, the mandrel body 88 could include other metal materials, such as alloy steel or stainless steel.

The magnets 92 each preferably present side surfaces 92a, a bottom surface 92b, and a top surface 92c (see FIG. 10). The illustrated side surfaces 92a are planar and parallel to one another. The bottom surface 92b is also preferably planar and extends orthogonally to the side surfaces 92a. The top surface 92c is preferably convex and presents the same radius as the inner sleeve surface 72 so that the magnet 92 and the curved plate 68 conform to one another. Each of the illustrated magnets 92 presents a length dimension that is larger than the width and height dimensions of the magnet 92. However, the principles of the present invention are equally applicable where the magnets 92 are alternatively shaped. For example, in some embodiments of the present invention, the magnets 92 preferably have a generally cylindrical shape where the axis of the cylindrical magnets extends along the length of the channel 100. Also, the magnets 92 could be configured so that the length dimension is shorter or longer than shown in the illustrated embodiment. When using the illustrated magnets 92 with the mandrel body 74, the operator can position a relatively large number of magnets 92 within the channels 100. The operator can also position spacers (not shown) in the channels 100, with each spacer located between a pair or more of magnets 92.

The magnet 92 preferably includes a permanent magnet material, such as neodymium or samarium-cobalt. However, the magnets 92 could each be provided by an electromagnet or ferrite magnets.

Each magnet 92 is positioned and secured in a corresponding one of the channels 100. Preferably, the magnets 92 are secured so that the top surfaces 92c of the magnets 92 are aligned with the outer receiving surface 96. That is, the outer receiving surface 96 and the top surfaces 92c preferably form a substantially continuous cylindrical surface.

A plurality of magnets 92 are positioned in series along each of the channels 100. The illustrated magnets 92 in each channel 100 could be spaced apart from one another (as shown in FIG. 6) and/or in abutting contact with one another. For instance, the magnets 92 could be in end-to-end abutting contact or in overlapping, side-to-side abutting contact with each other. Again, where the magnets 92 in the channel 100 are spaced apart from each other, the build mandrel 86 could also include spacers (not shown), with each spacer located between a pair or more of magnets 92.

The magnets 92 are also preferably secured within the channels 100 by a fastening structure (not shown) so that the fastening structure does not extend above the face of the single continuous cylindrical surface. That is, the fastening structure preferably does not interfere with placement of the curved plate 68 on the build mandrel 86. For instance, each magnet 92 could be secured to the mandrel body 88 with an adhesive (not shown) that is received entirely within the channels 100.

However, it is also within the scope of the present invention where no fastening structure is used to hold the magnets 92 on the build mandrel 86. For instance, the build mandrel 86 could include a magnetic material such that the magnets 92 are magnetically held within the channels 100.

The illustrated build mandrel 86 includes two magnet channels 100 arranged on opposite sides of the slot 98. However, the slot 98 and channels 100 of the build mandrel 86 could be alternatively formed. For instance, the build mandrel 86 might alternatively be constructed by forming a single channel to receive magnets and the slide (e.g., where the single channel has about the same overall width as the two channels 100 combined). In this alternative embodiment, alternative magnets could be sized so as to extend across the entire width of the single channel With the magnets fixed within the single channel, the slot can be formed by cutting radially through the magnets. That is, the slot can be formed by cutting a relatively small channel partially or completely through the thickness of the magnets.

Turning to FIGS. 9-11, the magnets 92 serve to securely and precisely hold the curved plate 68 on the build mandrel 86. The curved plate 68 is preferably positioned so that the seam 78 is positioned over and extends along the slot 98 of the build mandrel 86. At the same time, the end margins 76 are preferably positioned in overlying magnetic engagement with corresponding magnets 92. Thus, magnets 92 received in each channel 100 cooperatively hold a corresponding one of the end margins 76 in place against the build mandrel 86.

While the use of magnets 92 is preferred to secure the curved plate 68 to the mandrel 86, the principles of the present invention are applicable where an alternative fastening mechanism is used to removably secure the curved plate 68. For instance, the disclosed system could include one or more mechanical clamps to hold the curved plate 68 in place.

The slide 70 is preferably positioned in the slot 98 before the curved plate 68 is positioned on the build mandrel 86. However, the slide 70 could be located on the build mandrel 86 after the curved plate 68 (e.g., by sliding the slide 70 longitudinally into the slot 98). When the slide 70 and curved plate 68 are both appropriately positioned on the build mandrel 86, the slide 70 preferably engages both margins 76 along regions 110 (see FIG. 9) and spans the seam 78. Preferably, any gap dimension between the curved plate 68 and the slide 70 along the regions 110 ranges between about zero inches (0.0000″) and about eight ten-thousandths of an inch (0.0008″).

Turning to FIGS. 7-11, layers 80,82 in the form of flat sheets are initially cladded to one another to form the cladded flat plate. Prior to being formed into a cylinder, portions of the engravable layer 82 along the end margins 76 are preferably removed (see FIG. 7). Intermediate forms of the plate 68 are shown in FIGS. 7 and 8, and the intermediate or machined form of the plate (having the end margins 76 of the inner layer 80 exposed) is referenced herein by numeral 113. As will be discussed, endmost portions of the engravable layer 82 are preferably removed to facilitate attachment of the machined plate 113 to the slide 70.

The machined plate 113 is preferably formed around the build mandrel 86. The formed plate 113 is then welded to the slide 70 to form the sleeve 24. Preferably, forming of the machined plate 113 around the build mandrel 86 is completed before either end margin 76 is welded. However, one end margin 76 of the machined plate 113 could be at least partly welded to the slide 70 prior to curving the machined plate 113 around the mandrel. Again, to provide frictional engagement between the press mandrel 22 and rotary sleeve 24, the outer diameter dimension Dt of the build mandrel 86 is preferably slightly smaller than the outer mandrel diameter dimension Dm of the press mandrel 22 in the relaxed condition. However, it will be appreciated that the build mandrel 86 could be alternatively configured to vary the process by which the machined plate 113 is formed or the configuration of the sleeve 24 once it is fully formed. Also, for some aspects of the present invention, the press mandrel 22 could be used as the build mandrel.

The machined plate 113 is preferably formed around the build mandrel 86 to assume a substantially continuous cylindrical shape. Again, the machined plate 113 is curved around the build mandrel 86 so that the end margins 76 are located adjacent to one another and cooperatively form the longitudinal seam 78 that extends axially along the sleeve 24. The curved plate 68 is preferably positioned so that the seam 78 is positioned over and extends along the slot 98 of the build mandrel 86 (see FIG. 9). The end margins 76 are preferably positioned so that the magnets 92 cooperatively hold the end margins 76 in place against the build mandrel 86. When secured to the build mandrel 86, the longitudinal edges presented by margins 76 of the inner layer 80 preferably define a gap G extending along the seam 78 (see FIG. 9). The gap G preferably has a width dimension Dw (see FIG. 7) that ranges from about zero inches (0.000″) to about fifty thousandths of an inch (0.050″).

The curved plate 68 and slide 70 are preferably welded to one another while mounted on the build mandrel 86 so that the sleeve 24 has a unitary construction. Preferably, the curved plate 68 and slide 70 are welded together by two separate welding passes using a welding process. In a first welding pass, the inner layer 80 is welded to the slide 70 by a weld bead W1 that extends along weld zones 112 associated with the margins 76 (see FIG. 9). That is, the margins 76 are each fixed to the slide 70 and, consequently, the margins 76 are fixed relative to one another. As used herein, the term “weld zone” generally refers to the area in which material becomes temporarily liquified during the welding process.

Each weld zone 112 presents a zone width dimension Dz (see FIG. 9) that ranges from about fifteen thousandths of an inch (0.015″) to about fifty thousandths of an inch (0.050″) and, more preferably, is about twenty thousandths of an inch (0.020″). Also, the weld zones 112 cooperatively define a maximum weld width dimension Dx (see FIG. 9) that ranges from about forty thousandths of an inch (0.040″) to about one hundred thirty thousandths of an inch (0.130″).

In a second welding pass, a bead 114 of material is applied within the gap of the seam 78 (see FIG. 10). The bead 114 of weld material deposited during the second welding pass preferably includes a nonferrous material. For instance, the bead 114 preferably includes the same material (e.g. copper) as the engravable layer 82. The bead 114 of material is preferably deposited as a filler material to fill the seam 78 so that the outer surface can subsequently be made smooth and continuous across the seam 78. Furthermore, the weld material is deposited so that the seam 78 is filled with the weld material and an excess amount of weld material is also deposited above the seam 78 to form a generally convex bead surface 116 that projects radially outwardly from the margins 76 of the engravable layer 82 (see FIG. 10).

In the illustrated embodiment, the bead 114 of material applied during the second welding pass is preferably applied using a welding process. As a result of this second welding pass, the engravable layer 82 is welded so that the bead 114 joins the margins 76 of the engravable layer 82. However, the principles of the present invention are equally applicable where the bead 114 applied does not weld the margins 76 of the engravable layer 82 to each other.

The second welding pass is preferably performed once the first welding pass has been completed along the seam 78. While a laser process is preferred for performing both welding passes, the principles of the present invention are applicable to weld at least part of the seam 78 using an alternative process. For instance, the second welding pass to weld the margins 76 of the engravable layer 82 could be performed using a tungsten inert gas (TIG) welding process or brazing. Yet further, in the event that the bead 114 does not weld the margins 76 of the engravable layer 82 to one another, other material deposition processes could be used to apply the bead 114 so that the bead operates to fill the seam 78.

While the bead 114 is applied as the only filler material, it is within the scope of the present invention where one or more additional materials are used as a filler to fill the seam 78. Also, while the second welding pass is performed to fill the seam 78, it will be understood that one or more additional welding passes could be performed to collectively fill the seam 78.

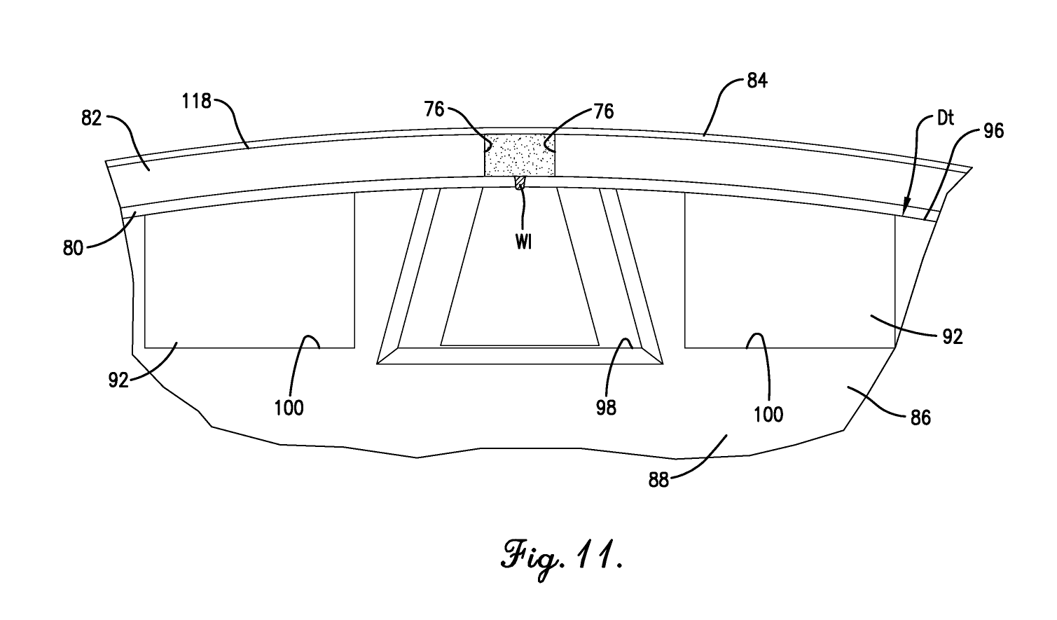

Once the welding processes are complete, an excess portion of the bead 114 can be removed by grinding the bead 94 down to the finished outer diameter of the engravable layer 82 (see FIG. 11). The illustrated sleeve 24 preferably remains mounted on the build mandrel 86 while excess weld material is removed. However, in another preferred embodiment, the sleeve 24 could be mounted on a second build mandrel (not shown), separate from the build mandrel 70, for supporting the sleeve while excess weld material is being removed. An excess portion of the bead 114 is removed so that the outermost surface of the curved plate 52 has a continuous radius and is smooth across the seam 78 from one of the margins 60 to the other one of the margins 60. Preferably, the continuous outermost surface is formed by grinding along the bead 114 and the engravable layer 82 to remove outer portions of the bead 114 and the engravable layer 82. The grinding is preferably done continuously about the sleeve 24 to form a smooth continuous finished outer surface. This finished outer surface is preferably continuous across the seam 78 from one end margin 76 to the other end margin 76.

The engravable layer 82 is preferably then engraved to produce an engraved surface 118, with the engraved surface 118 defining image indicia 120 (see FIG. 11). The engraved features of the engraved surface 118 are preferably formed by laser engraving, but other conventional engraving techniques can be used to form the engraved surface 118 (such as photo-etching, manual engraving, or machining). Furthermore, it is possible according to some aspects of the present invention, for the layer 82 to be engraved while the plate 68 is flat (i.e., before it is formed into the cylindrical sleeve).

It will be appreciated that elimination of the seam 78 (by filling the seam 78 with the bead 114 and then grinding excess portions of the bead 114 and the engravable layer 82) enables the finished outer surface to be suitably engraved and used for rotogravure printing, embossing, debossing, texturing, and hot foil stamping. Notably, the absence of any surface depression or other discontinuity along the seam 78 and outside of the image indicia 120 enables the image indicia 120 to extend over the seam 78. That is, positioning the image indicia 120 across the seam 78 does not undesirably affect the substrate (e.g., by introducing a stray printing mark during rotogravure printing).

With the engraved surface 118 completed, the plated layer 84 can then be applied to cover the engravable layer 82. Again, the plated layer 84 preferably includes a nickel or chrome material, but could include an alternative material for covering the engraved surface 118 with a suitably hard, non-stick, and wear-resistant covering. Preferably, the outer sleeve surface 74 presented by the plated layer 84 has a continuous radius and is smooth across the seam 78 (at least along surface locations spaced from the image indicia 120) from one of the margins 76 to the other one of the margins 76. However, it is within the ambit of the present invention where the sleeve 24 does not include the plated layer 84. For instance, the outer sleeve surface 74 could be presented by the engravable layer 82.

To secure the sleeve 24 onto the press mandrel 22, the sleeve 24 is removably slidable onto and off of the press mandrel 22. Again, in the illustrated embodiment, the mandrel body 26 is operable to slidably receive the sleeve 24 when the mandrel body 26 is shifted into in the contracted condition. As discussed, the clamps 32 are temporarily secured on the mandrel body 26 (by inserting studs 50 in the holes 38). The screws 52 are then threaded into the clamp bodies 48 so that the mandrel body 26 is shifted from the relaxed condition to the contracted condition. In the contracted condition, the diameter Dm is preferably less than the inner sleeve diameter Ds of the sleeve 24. Thus, the sleeve 24 can be slidably positioned on the mandrel body 26 by moving the sleeve 24 axially along the mandrel body 26.

Mounting of the sleeve 24 begins by aligning the slot 42 and the slide 70 with one another in an end-to-end arrangement. With the slot 42 and the slide 70 aligned, the sleeve 24 can be moved axially onto the mandrel body 26, with one end of the slide 70 being inserted into the slot 42. Again, the slide 70 and slot 42 are preferably complementally sized and shaped to permit axial insertion and removal of the slide 70 relative to the slot 42. Furthermore, the slot 42 and the slide 70 preferably engage one another when the sleeve 24 is mounted on the press mandrel 22.

With the sleeve 24 in a desired axial position along the mandrel 22, the sleeve 24 can be secured by releasing the clamps 32 so that the mandrel body 26 resiliently returns toward the relaxed condition. Specifically, the mandrel body 26 expands to an engaged condition where the press mandrel 22 and the sleeve 24 are frictionally engaged with one another. The clamps 32 are released by threading the screws 52 out of the clamp bodies 48 so that the mandrel body 26 shifts from the contracted condition toward the engaged condition. The clamp bodies 48 and threaded studs 50 can then be removed from the mandrel body 26. It will be understood that the clamp bodies 48 are configured to be connected to and removed from the studs 50 when the mandrel body 26 is in either the relaxed condition or the engaged condition. That is, the slotted opening 56 of the clamp body 48 is sized and positioned so that the clamp body 48 can be freely mounted or removed from the studs 50 when the studs are positioned in the relaxed condition or in the engaged condition.

In the illustrated embodiment, the mandrel body 26 preferably does not return to the relaxed condition with the sleeve 24 mounted thereon. That is, the diameter Dm associated with the engaged condition is less than the diameter Dm associated with the relaxed condition. This occurs because the diameter Dm associated with the relaxed condition is preferably larger than the inner sleeve diameter Ds of the sleeve 24. Consequently, the mandrel body 26 applies a radially outward retaining force to the sleeve 24 when the sleeve 24 is mounted and the clamps 32 are released. This retaining force creates frictional engagement between the mandrel body 26 and the sleeve 24 and restricts relative axial movement therebetween.

With the sleeve 24 frictionally retained on the mandrel body 26, the clamps 32 are preferably removed and the end caps 28 can be removably attached to the mandrel body 26 with screws 30. Again, when the body 26 is in the engaged condition, the holes 66 of the end caps 28 are preferably in registration with corresponding ones of the threaded holes 38. However, it is within the scope of the present invention where the holes 66 are oversized and/or slotted to accommodate for the expanded condition of the mandrel body 26. With the end caps 28 attached to the body 26, the assembly 20 can then be operably mounted on a rotary machine (not shown).

It is within the ambit of the present invention where the assembly 20 is alternatively configured to removably secure the sleeve 24 on the mandrel body 26. For instance, as will be described in a subsequent embodiment, the press mandrel 22 could be cooled relative to the temperature of the sleeve 24 so that the outer mandrel diameter Dm is reduced to permit the sleeve 24 to slide onto the press mandrel 22.

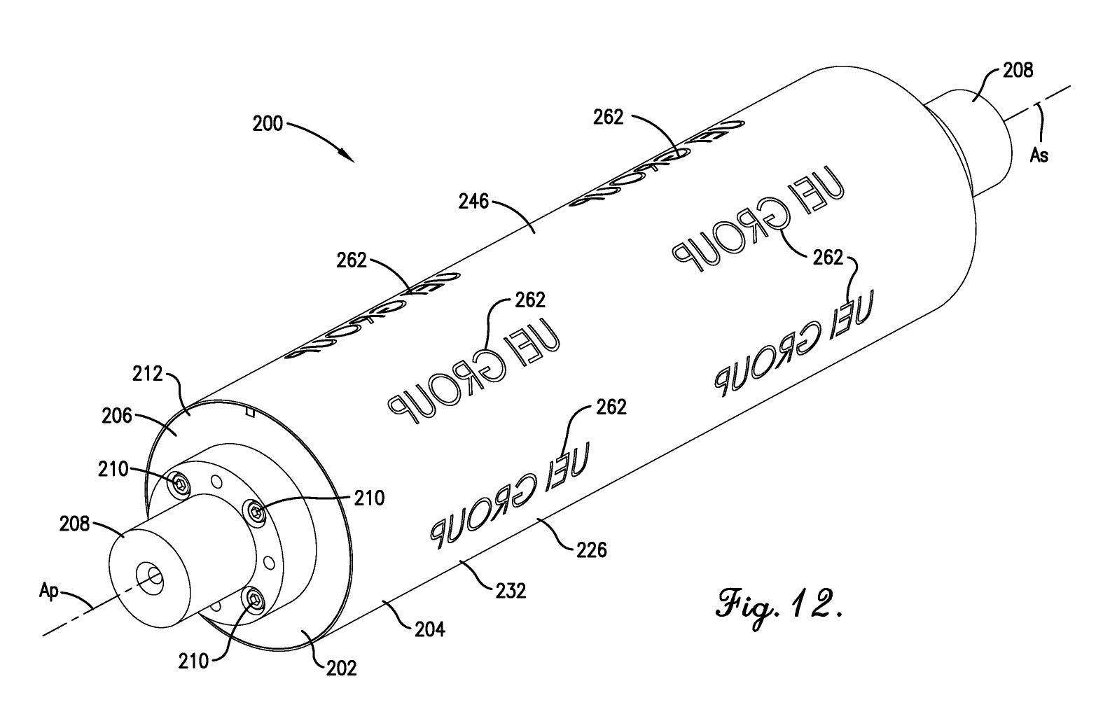

Turning to FIGS. 12-19, an alternative graphic arts assembly 200 is constructed in accordance with a second preferred embodiment of the present invention. For the sake of brevity, the remaining description will focus primarily on the differences of this alternative embodiment from the embodiment described above.

Initially turning to FIGS. 12-14, the graphic arts assembly 200 preferably includes a press mandrel 202 and an engraved sleeve 204. As will be described, the mandrel 202 preferably has a fixed outer dimension. Furthermore, the sleeve 204 is formed of an alternative construction than the sleeve 24 shown in FIGS. 1-11.

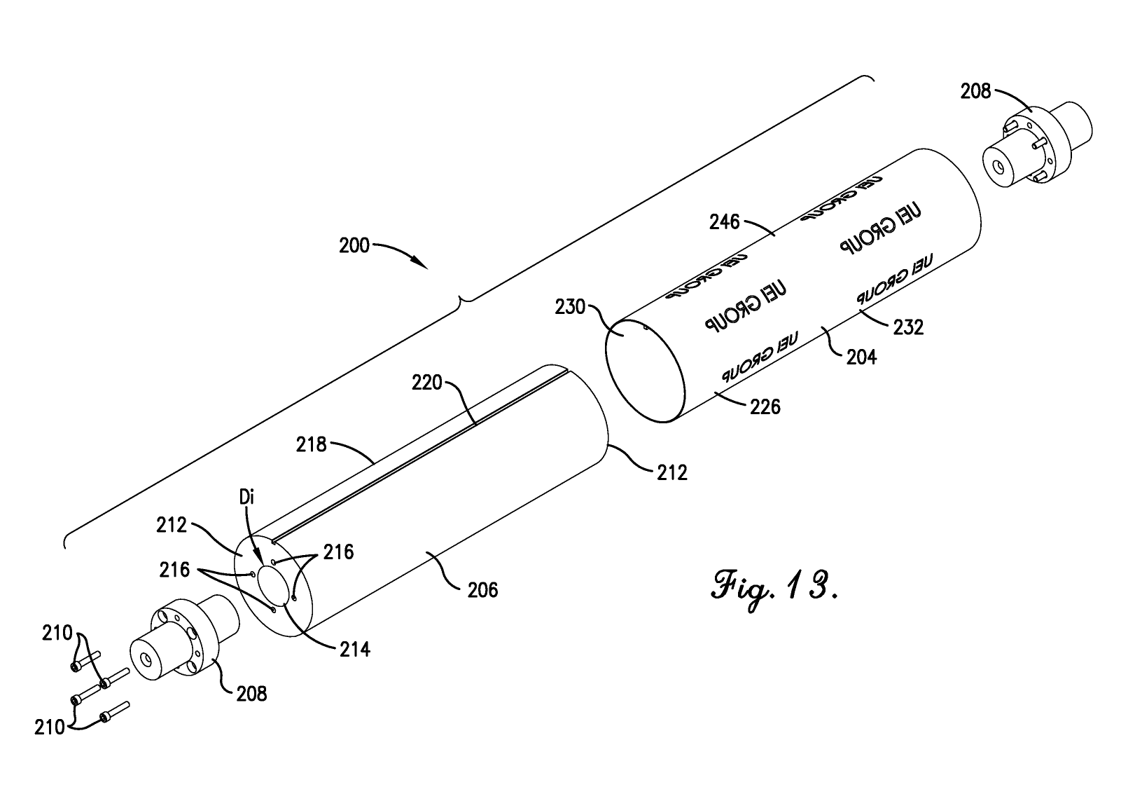

In the illustrated embodiment, the press mandrel 202 preferably includes a mandrel body 206, end caps 208, and screws 210. The mandrel body 206 comprises a generally cylindrical tube and presents opposite tube ends 212 and a cylindrical passage 214 that extends from one end 212 to the other end 212. The preferred cylindrical passage 214 defines an inner mandrel diameter dimension Di (see FIG. 13) that is substantially constant along the length of the mandrel 202, although alternative internal passage configurations are within the scope of the present invention. Each of the ends 212 presents threaded holes 216.

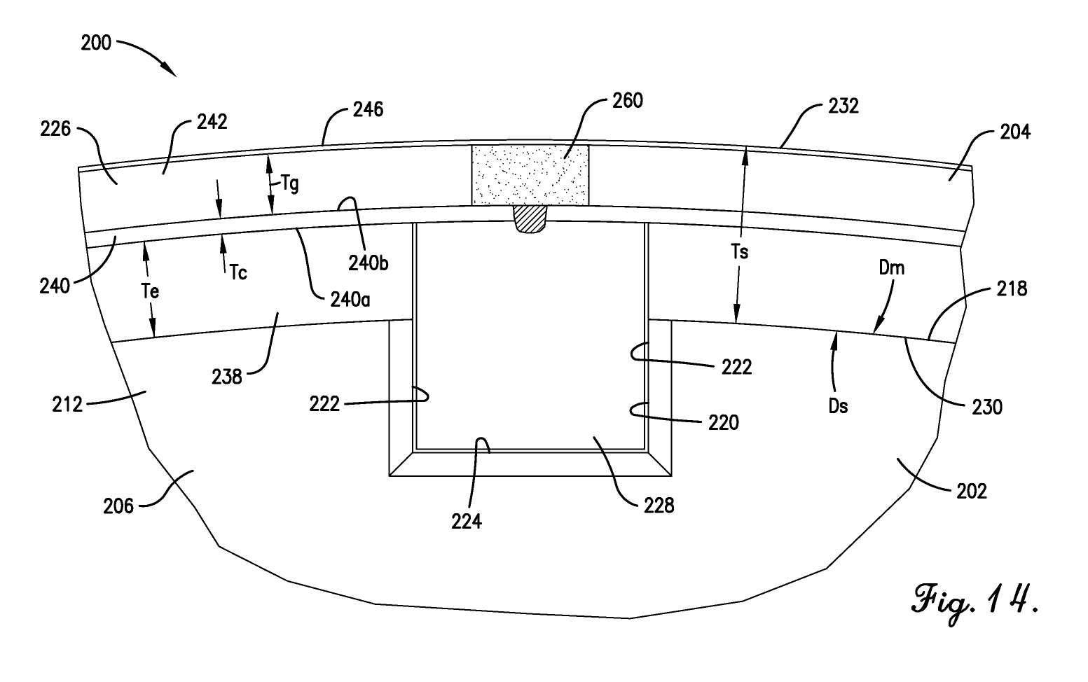

The mandrel body 206 also preferably presents a cylindrical outer receiving surface 218 and a longitudinal slot 220 (see FIG. 14). The outer receiving surface 218 defines an outer mandrel diameter dimension Dm (see FIG. 14) that is substantially constant along the length of the mandrel 202. The slot 220 is defined by opposite side faces 222 and a bottom face 224 presented by the mandrel body 206, with the ends of the faces 222,224 being chamfered (see FIG. 14). The illustrated slot 220 preferably presents a generally square cross-sectional shape, with side faces 222 and bottom face 224 being generally equal in dimension. The slot 220 extends longitudinally along the axis Ap (see FIG. 12) of the press mandrel 202 and intersects the receiving surface 218. Preferably, the slot 220 presents an axis that is parallel to the axis Ap.

Turning to FIGS. 12-19, the rotary sleeve 204 is preferably configured to be secured on the press mandrel 202 via an interference fit. As will be explained, a sufficient temperature differential is preferably created between the rotary sleeve 204 and the mandrel body 206 so that the sleeve 204 slides onto the receiving surface 218. This is preferably accomplished by heating the sleeve 204 to a temperature higher than the body 206. The rotary sleeve 204 preferably includes a plate 226 and an elongated slide 228 that cooperatively present a unitary sleeve construction. The rotary sleeve 204 preferably presents inner and outer sleeve surfaces 230,232 (see FIG. 14).

The plate 226 is preferably unitary, with the plate initially being flat and then curved into a cylindrical tubular shape to define a central sleeve axis As (see FIG. 12). If desired, the plate 226 may be formed of a flexible material so as to prevent plastic deformation as the plate 226 is curved into the desired cylindrical shape. The plate 226 presents plate margins 234 which are positioned adjacent one another when the plate 226 is formed into a cylindrical shape (see FIG. 16). Once the plate 226 is formed into the cylinder shape, it preferably generally maintains the shape in the absence of external forces (such as flexing forces). The inner sleeve surface 230 defines an inner sleeve diameter dimension Ds (see FIG. 16). Preferably, the plate margins 234 are positioned adjacent one another and cooperatively form a longitudinal seam 236 that extends along the length of the curved plate 226. Similar to the previous embodiment, as will be described, the illustrated margins 234 are fixed relative to one another, and the seam 236 is suitably filled so that the outer surface 232 is smooth and continuous.

Turning to FIGS. 14-19, the plate 226 is cooperatively formed by an underlying expansion layer 238, an intermediate, perforated, carrier layer 240, and an overlying engravable layer 242. These layers 238,240,242 are preferably provided in the form of flat sheets that are cladded to one another to form an integral, cladded flat plate (not shown). As will be discussed, the rotary sleeve 204 may also include an outermost plated layer 246 (see FIG. 14), which is applied to the curved plate 226 after the curved plate 226 is welded to the slide 228 and the desired image is formed in the engravable layer 242. The expansion layer 238 presents the inner sleeve surface 230 and the plated layer 246 presents the outer sleeve surface 232.

The layers 238,240,242,246 of the curved plate 226 are preferably configured so that heating of the sleeve 204 to a temperature higher than the ambient temperature temporarily enlarges the sleeve 204. The sleeve 204 can then be cooled for securement to the mandrel 202 in an interference fit. During use in a hot foil stamping process, it will be understood that both the mandrel 202 and the sleeve 204 are heated after being secured to one another. However, the mandrel 202 and sleeve 204 remain in frictional engagement with one another when heated during the hot foil stamping process.

To provide suitable expansion, the expansion layer 238 preferably includes a material with a greater coefficient of thermal expansion than the material used to form the carrier layer 240. In the illustrated embodiment, the expansion layer 238 preferably includes an aluminum alloy material and, more preferably, the expansion layer 238 comprises aluminum alloy 6061. The carrier layer 240 preferably includes a stainless steel alloy material and, more preferably, comprises an SAE 304 stainless steel material. The SAE 304 stainless steel material is substantially nonmagnetic.

However, it is within the scope of the present invention for the expansion layer 238 to include an additional or alternative metal material. For instance, the expansion layer 238 may be formed of an alternative aluminum alloy, or another suitable metal having a greater expansion rate than the carrier layer 240. Similarly, the carrier layer 240 may also be formed of an additional or alternative metal. For example, the carrier layer 240 may be formed of an alternative stainless steel alloy, a nonstainless steel alloy, or another suitable metal for the expansion layer 238.

The expansion layer 238 also preferably presents a thickness dimension Te greater than a thickness dimension Tc of the carrier layer 240 (see FIG. 14). The thickness dimension Te of the expansion layer 238 preferably ranges from about twenty-four thousandths of an inch (0.024″) to about sixty thousandths of an inch (0.060″) and, more preferably, is about forty-eight thousandths of an inch (0.048″). The thickness dimension Tc of the carrier layer 240 preferably ranges from about four thousandths of an inch (0.004″) to about twelve thousandths of an inch (0.012″) and, more preferably, is about eight thousandths of an inch (0.008″).

Preferably, the carrier layer 240 presents a pattern of perforations (not shown) that project through the carrier layer 240 from an inner surface 240a to an outer surface 240b (see FIG. 14). The perforations preferably have a uniform size and shape and are uniformly distributed along the length and width of the carrier layer 240. For each surface 240a,b, the perforations are preferably sized and distributed so that the percentage of the nonperforated area of the surface 240a,b to the total area of the surface 240a,b (including the perforations and the solid portion of the carrier layer 240) ranges from about twenty percent (20%) to about sixty percent (60%). More preferably, the ratio of the nonperforated area of the surface 240a,b to the total area of the surface 240a,b is about forty percent (40%). It will be appreciated that the perforations can be variously shaped and/or sized without departing from the scope of the present invention.

In the preferred embodiment, the relative layer thicknesses, the relative coefficients of expansion for the layers 238,240, and the perforations formed in the layer 240 cooperatively allow the sleeve 204 and press mandrel 202 to be selectively secured to and removed from each other by a sufficient temperature differential therebetween. In particular, the use of the relatively thicker expansion layer 238 overcomes the limited expansion of the carrier layer 240 and drives the overall dimension of the sleeve 204, e.g., when the sleeve 204 is heated to a sleeve expansion temperature for sleeve installation or sleeve removal (as will be described below). The materials selected for the expansion and carrier layers 238,240 and their respective coefficients of thermal expansion will also impact the construction of the plate. For example, with some suitable configurations, the expansion and carrier layers 238,240 may have the same thickness. It may also be possible with some configurations to eliminate the need for perforations.

In general, the preferred sleeve configuration preferably causes the carrier layer 240 to undergo elastic deformation when heated to the sleeve expansion temperature. In some instances, heating the sleeve 204 to the sleeve expansion temperature could stretch the carrier layer 240 beyond its yield point such that the carrier layer 240 undergoes plastic deformation. However, for at least some aspects of the present invention, such excessive deformation of the carrier layer 240 is not preferred. It will be appreciated that the layer thicknesses, the coefficients of expansion, and/or the carrier layer perforations could be alternatively configured without departing from the scope of the present invention.

The engravable layer 242 defines a thickness dimension Tg (see FIG. 14). Prior to being engraved, the thickness dimension Tg of the engravable layer 242 preferably ranges from about one thousandth of an inch (0.001″) to about forty thousandths of an inch (0.040″) and, more preferably, is about four thousandths of an inch (0.004″). The engraving that defines image indicia on the engravable layer 242 preferably has a depth that ranges from about three hundred-thousandths of an inch (0.00003″) to about thirty-five thousandths of an inch (0.035″). After being engraved, the engravable layer 242 preferably presents a minimum thickness dimension (generally along the engraved area forming the image indicia) that ranges from about five ten-thousandths of an inch (0.0005″) to about five thousandths of an inch (0.005″).

The total sleeve thickness dimension Ts (see FIG. 14), including the plated layer 246, preferably ranges from about twenty thousandths of an inch (0.020″) to about eighty thousandths of an inch (0.080″) and, more preferably is about sixty thousandths of an inch (0.060″).

The engravable layer 242 preferably comprises a copper material, but could include an alternative metal material (such as another nonferrous alloy) without departing from the scope of the present invention. Suitable alternative materials include bronze and magnesium.

The plated layer 246 preferably includes a nickel or chrome material, but could include an alternative material for suitably covering the engraved surface of the engravable layer 242. The plated layer 246 is preferably applied to the engravable layer 242 after the layer 242 is engraved.

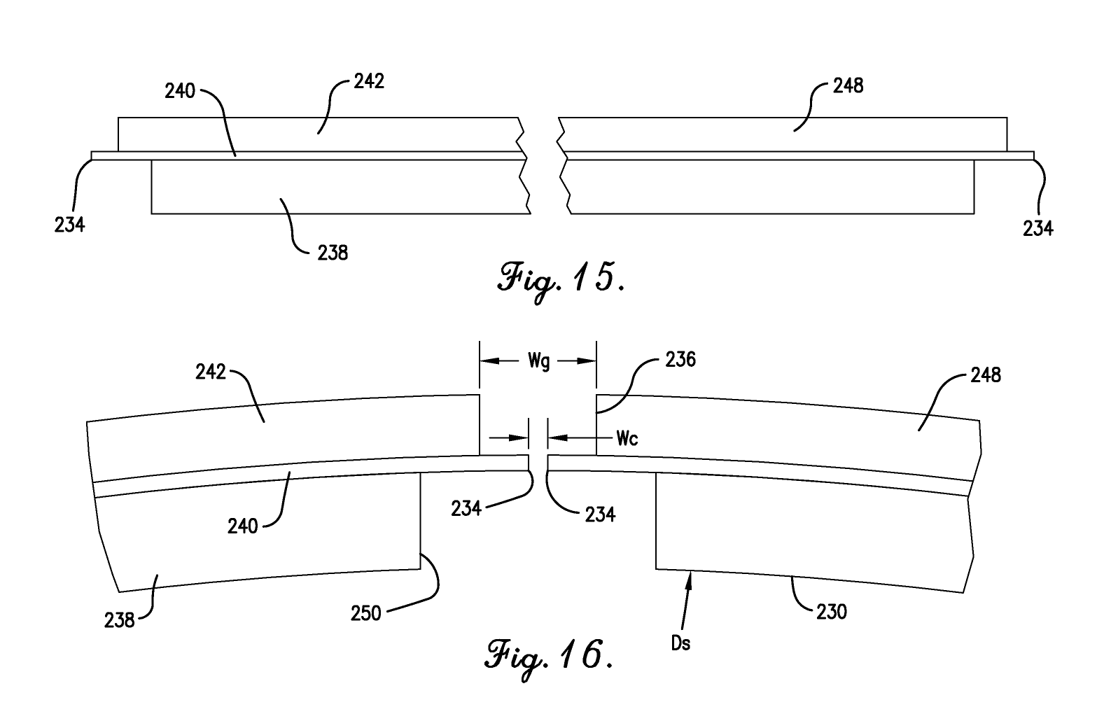

Turning to FIGS. 15-19, the layers 238,240,242 in the form of flat sheets are preferably cladded to one another to form the cladded flat plate. Similar to the previous embodiment, portions of the expansion layer 238 and the engravable layer 242 along the end margins 234 are then preferably removed before forming the flat plate into a cylinder (see FIG. 15). The flat plate is then formed around a build mandrel (not shown) to produce an intermediate or machined form of the plate, which is referenced herein by numeral 248 (see FIG. 16). As will be discussed, endmost portions of the expansion layer 238 are preferably removed so that the end margins 234 form a channel that receives the slide 228. Also, endmost portions of the engravable layer 242 are preferably removed to facilitate attachment of the machined plate 248 to the slide 228.

The machined plate 248 is preferably formed around a build mandrel (not shown), similar to build mandrel 86. The formed plate 248 is then welded to the slide 228 to form the sleeve 204. Preferably, forming of the machined plate 248 around the build mandrel is completed before either end margin 234 is welded. However, one margin 234 of the machined plate 248 could be at least partly welded to the slide 228 prior to curving the machined plate 248 around the mandrel. To provide the interference fit between the press mandrel 202 and rotary sleeve 204, the build mandrel preferably presents an outer diameter dimension that is slightly smaller than the outer mandrel diameter dimension Dm of the press mandrel 202. However, it will be appreciated that the build mandrel could be alternatively configured to vary the process by which the machined plate 248 is formed or the configuration of the sleeve 204 once it is fully formed. Also, for some aspects of the present invention, the press mandrel 202 could be used as the build mandrel.

The machined plate 248 is preferably formed around the build mandrel to assume a substantially continuous cylindrical shape (see FIGS. 12 and 13). Again, the machined plate 248 is curved around the build mandrel so that the margins 234 are located adjacent to one another and cooperatively form the longitudinal seam 236 that extends axially along the sleeve 204 (see FIG. 16). Along the illustrated seam 236, the margins 234 of the carrier layer 240 preferably cooperatively define a gap that presents a carrier layer gap dimension Wc (see FIG. 16). The carrier layer gap dimension Wc preferably ranges from about zero inches (0.000″) to about ten thousandths of an inch (0.010″).

Also, the margins 234 of the engravable layer 242 preferably cooperatively define a gap that presents an engravable layer gap dimension Wg (see FIG. 16). The engravable layer gap dimension Wg preferably ranges from about forty thousandths of an inch (0.040″) to about eighty thousandths of an inch (0.080″). As will be discussed, the gap in the engravable layer 242 is preferably filled after the carrier layer 240 is welded to the slide 228.

The margins 234 also cooperatively define a longitudinal channel 250 to receive the slide 228 (see FIG. 16). The illustrated channel 250 preferably presents a cross-sectional shape that is substantially continuous along the length of the sleeve 204. The channel 250 is formed so that the slide 228 can be positioned in direct engagement with and fixed directly to the carrier layer 240. Preferably, the slide 228 is welded to the carrier layer 240. However, the slide 228 and carrier layer 240 could be otherwise fixed to one another (e.g., by being integrally formed). In the illustrated embodiment, the channel 250 is formed by removing the endmost portions of the expansion layer 238. However, it will be appreciated that the channel 250 could be alternatively formed to permit direct engagement between the slide 228 and the carrier layer 240. For instance, the expansion layer 238 could be shorter than the carrier layer 240 prior to cladding of the layers 238,240 to one another.

It will be appreciated that the slide 228 could be fixed directly to the expansion layer 238 (e.g., by welding the slide 228 to the expansion layer 238). For instance, the slide 228 could be welded to the inner sleeve surface 230 without removing the endmost portions of the expansion layer 238.

Furthermore, the channel 250 could alternatively be formed to allow the slide 228 to be fixed directly to the engravable layer 242 (e.g., by welding the slide 228 to the engravable layer 242). For instance, to fix the slide 228 to the engravable layer 242, the channel 250 could be formed by removing endmost portions of the expansion layer 238 and of the carrier layer 240 so as to expose the underside of the engravable layer 242. In this alternative configuration, the slide is preferably formed of the same material as the engravable layer 242.

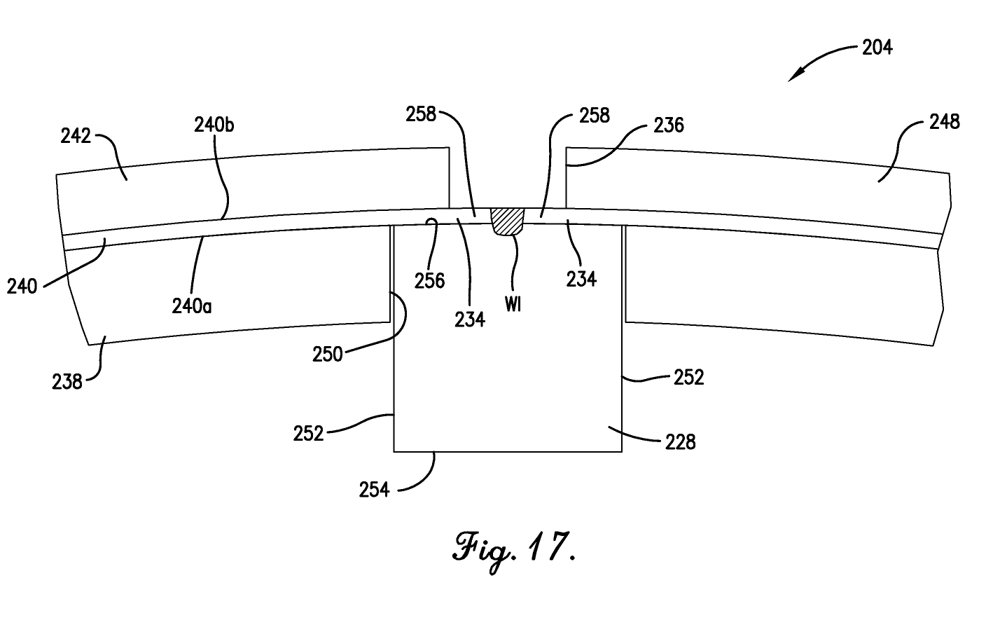

The illustrated slide 228 comprises a unitary rod that presents side surfaces 252, a bottom surface 254, and a top surface 256 (see FIG. 17). The side surfaces 252 are preferably planar and parallel to one another. The bottom surface 254 is also preferably planar and extends orthogonally to the side surfaces 252.

The top surface 256 is preferably a substantially planar surface that is positionable alongside the inner surface 240a. However, the top surface 256 could have a convex shape (e.g., where the top surface 256 presents the same radius as the inner surface 240a so that the slide 228 and the carrier layer 240 conform to one another prior to being welded together). However, the sleeve 204 could be alternatively configured to provide conforming engagement. For instance, the inner surface 240a could include flat surface sections along the margins 234 that engage corresponding planar top surfaces of the slide 228.

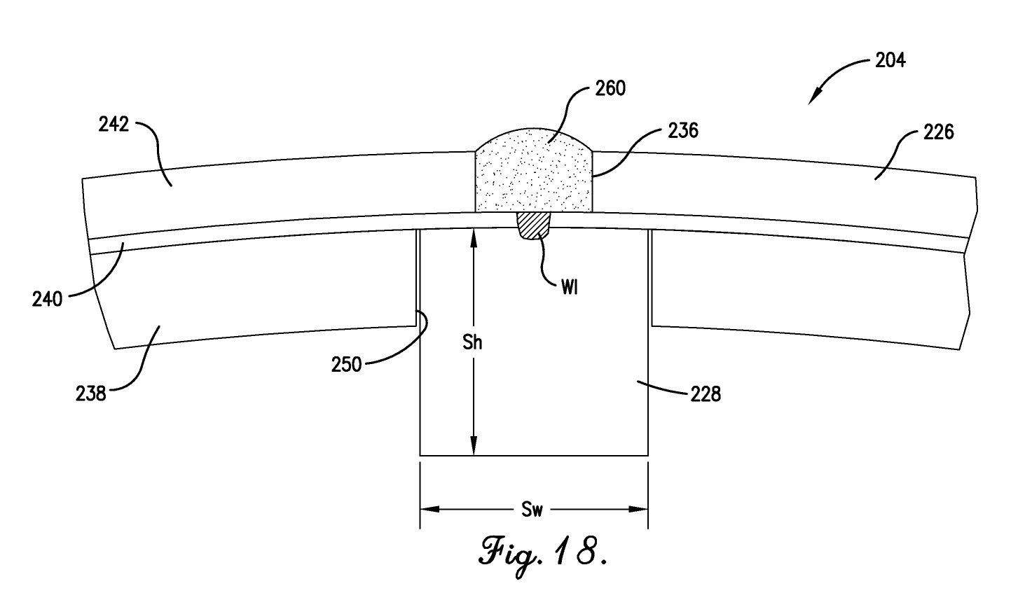

The slide 228 preferably presents a height dimension Sh and a width dimension Sw (see FIG. 18). The dimensions Sh,Sw are preferably the same and range from about one hundred thousandths of an inch (0.100″) to about two hundred fifty thousandths of an inch (0.250″). The slide 228 preferably includes an alloy steel material, but could include other materials.

The illustrated slide 228 preferably projects radially inwardly relative to the inner sleeve surface 230. However, for some aspects of the present invention, the bottom surface 254 of the slide 228 could be substantially flush with the inner sleeve surface 230 or spaced radially outwardly from the inner sleeve surface 230 (e.g., where the interference fit between the press mandrel 202 and the sleeve 204 is sufficient to restrict relative rotation therebetween).

The curved plate 226 and slide 228 are welded to one another so that the rotary sleeve 204 has a unitary construction and presents the inner sleeve diameter dimension Ds. Furthermore, the rotary sleeve 204 is preferably constructed to be mounted on the press mandrel 202 with an interference fit when the assembly 20 is at the press operating temperature. Most preferably, for printing, embossing, debossing, and texturing, the press operates at room temperature. The rotary sleeve 204 is sized so that the inner sleeve diameter dimension Ds is equal to or slightly undersized relative to the outer mandrel diameter dimension Dm. Preferably, the difference of the outer mandrel diameter dimension Dm minus the inner sleeve diameter dimension Ds (Dm−Ds) preferably ranges from about zero inches (0.0000″) to about fifteen ten-thousandths of an inch (0.0015″) when the rotary sleeve 204 and the press mandrel 202 are at room temperature. As will be discussed, a temperature differential is preferably created between the rotary sleeve 204 and the press mandrel 202 to permit the rotary sleeve 204 to be mounted onto the press mandrel 202. The sleeve 204 is preferably heated relative to the press mandrel 202, although it is within the ambit of the present invention where the press mandrel 202 is cooled to permit mounting of the sleeve 204 onto the press mandrel 202.

It is also possible with some alternative assembly configurations for both the mandrel 202 and the sleeve 204 to be heated or cooled to the same degree. For instance, different rates of expansion or contraction of the sleeve 204 and the body 206 could provide enough of a variance between the outer diameter of the mandrel 202 and the inner surface of the sleeve 204 to allow for mounting or removal. Furthermore, if the illustrated assembly 200 is used for hot foil stamping, the desired interference fit is maintained when the assembly 200 is heated during hot foil stamping operations.

The plate 226 and slide 228 are preferably welded to one another while mounted on the build mandrel so that the rotary sleeve 204 has a unitary construction. Preferably, the plate 226 and slide 228 are welded together by two separate welding passes using a welding process. In a first welding pass, the carrier layer 64 is welded to the slide 54 by a weld bead W1 that extends along weld zones 258 associated with the margins 234 (see FIG. 17). That is, the margins 234 are each fixed to the slide 228 and, consequently, the margins 234 are fixed relative to one another. The first welding pass is preferably done by laser welding, although other types of welding could be used. As used herein, the term “weld zone” generally refers to the area in which material becomes temporarily liquified during the welding process.

In a second welding pass, a bead 260 of material is applied within the gap of the seam 236 (see FIG. 18). The bead 260 of weld material deposited during the second welding pass preferably includes a copper material (although the weld material could include another nonferrous material, such as tin, nickel, etc.).

In the illustrated embodiment, the bead 260 applied during the second welding pass is preferably applied using a laser welding process. It is also within the scope of the present invention where an alternative welding process is used for the second welding pass, such as TIG welding or brazing. As a result of this second welding pass, the engravable layer 242 is welded so that the bead 260 joins the margins 234 of the engravable layer 242.

The second welding pass is preferably performed once the first welding pass has been completed along the seam 236. While a welding process is preferred for performing both welding passes, the principles of the present invention are applicable to weld at least part of the seam 236 using an alternative process. For instance, in the event that the bead 260 does not weld the margins 234 of the engravable layer 242 to one another, other material deposition processes could be used to apply the bead so that the bead operates to fill the seam 236, such as a soldering process.

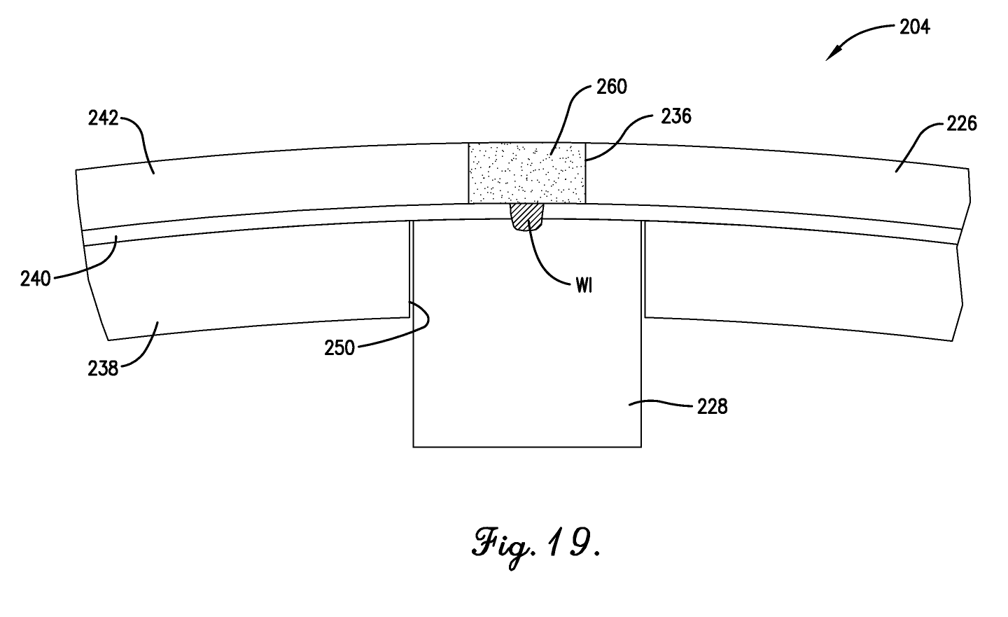

Once the welding processes are complete, excess portions of the bead 260 are preferably removed by grinding the bead 260 down to the finished outer diameter of the engravable layer 242 (see FIG. 19). The illustrated sleeve preferably remains mounted on the build mandrel while excess weld material is removed. Preferably, the bead 260 is removed so that the outermost surface of the curved plate 226 has a continuous radius and is smooth across the seam 236 from one of the margins 234 to the other one of the margins 234.

The engravable layer 242 is preferably then engraved to produce an engraved surface that defines image indicia 262 (see FIG. 12). As discussed, the engraved features of the engraved surface are preferably formed by laser engraving, but other conventional engraving techniques can be used to form the engraved surface (such as photo-etching, electromechanical engraving, manual engraving, or machining) Because the seam 236 is filled, the image indicia 262 can extend across the seam 236, although such positioning of the indicia 262 is not required. For some aspects of the present invention, the layer 242 could also be engraved while the plate 226 is flat (i.e., before it is formed into the cylindrical sleeve).

With the engraved surface completed, the plated layer 246 can then be applied to cover the engravable layer 242 (see FIG. 14). Again, the plated layer 246 preferably includes a nickel or chrome material, but could include an alternative material for covering the engraved surface with a suitably hard, non-stick, and wear-resistant covering. Preferably, the outer sleeve surface 232 presented by the plated layer 246 has a continuous radius and is smooth across the seam 236 (at least along surface locations outside the image indicia 262). However, it is within the ambit of the present invention where the sleeve 204 does not include the plated layer 246. For instance, the outer sleeve surface 232 could be presented by the engravable layer 242.

To secure the rotary sleeve 204 onto the press mandrel 202, the rotary sleeve 204 is preferably heated above the temperature of the press mandrel 202 to permit the rotary sleeve 204 to be mounted onto the press mandrel 202. More specifically, the sleeve 204 is heated relative to the press mandrel 202 to the sleeve expansion temperature so that the inner sleeve diameter dimension Ds is greater than the outer mandrel diameter dimension Dm. The sleeve expansion temperature preferably ranges from about one hundred eighty degrees Fahrenheit (180° F.) to about four hundred degrees Fahrenheit (400° F.), while the press mandrel 202 is maintained at or about the ambient temperature. When heated to the sleeve expansion temperature for sleeve installation, the carrier layer 240 preferably undergoes elastic deformation. With the rotary sleeve 204 heated, the rotary sleeve 204 can slide over and onto the press mandrel 202, with the slide 228 received in the slot 220.

However, for some aspects of the present invention, the press mandrel 202 could be cooled to a temperature below the ambient temperature to reduce the outer mandrel diameter dimension Dm. Such cooling of the press mandrel 202 could be done as an alternative to heating of the rotary sleeve 204 or in combination with heating of the rotary sleeve 204.

As discussed above, it has been found that the relative layer thicknesses, the relative coefficients of expansion for the layers 238,240, and the perforations formed in the layer 240 cooperatively allow the sleeve 204 and press mandrel 202 to be selectively secured and removed from each other by heating the sleeve 204. In particular, the use of the relatively thicker expansion layer 238 overcomes the limited expansion of the carrier layer 240 and drives the overall expansion of the sleeve 204 when the sleeve 204 is heated to the sleeve expansion temperature. Again, for sleeve installation, the preferred sleeve configuration preferably causes the carrier layer 240 to undergo elastic deformation when heated to the sleeve expansion temperature.

The layers 238,240,242,246 cooperatively provide an overall thermal expansion coefficient of the sleeve 204, with thermal expansion of the illustrated sleeve 204 being driven mostly by the expansion layer 238. Again, the expansion layer 238 preferably includes an aluminum alloy material that is different than the material of the press mandrel 202 (i.e., so that the expansion layer 238 has a greater coefficient of thermal expansion than the press mandrel 202). Furthermore, the overall thermal expansion coefficient of the sleeve 204 (cooperatively provided by the illustrated layers 238,240,242,246) is preferably greater than the thermal expansion coefficient of the press mandrel 202. Consequently, when the sleeve 204 is mounted to the press mandrel 202, both can be heated together to permit the sleeve 204 to be slidably removed from the press mandrel 202.

The rotary sleeve 204 is preferably selectively removable from the press mandrel 202. Preferably, the sleeve 204 and the press mandrel 202 are both heated to a temperature above ambient so that the inner sleeve diameter dimension Ds is about equal to or greater than the outer mandrel diameter dimension Dm. In particular, the sleeve 204 and the press mandrel 202 are heated to a sleeve expansion temperature that preferably ranges from about four hundred fifty degrees Fahrenheit (450° F.) to about five hundred fifty degrees Fahrenheit (550° F.). Because the overall thermal expansion coefficient of the sleeve 204 is greater than the thermal expansion coefficient of the press mandrel 202, the press mandrel 202 and sleeve 204 can be heated together so that the sleeve 204 is capable of being slid off of the mandrel 202. It is also within the scope of the present invention where the press mandrel 202 and sleeve 204 are heated during sleeve removal so that the temperature of the press mandrel 202 is generally above the ambient temperature (due to heat conduction from the sleeve 204 to the press mandrel 202), but at a temperature below the sleeve expansion temperature. Furthermore, the press mandrel 202 could also be cooled to a temperature at or below the ambient temperature to reduce the outer mandrel diameter dimension Dm. Again, such cooling of the press mandrel 202 could be done as an alternative to heating of the rotary sleeve 204 or in combination with heating of the rotary sleeve 204.

When heated to the sleeve expansion temperature for removal of the sleeve 204, the carrier layer 240 preferably undergoes plastic deformation, such that the carrier layer 240 is stretched beyond its yield point. However, heating the sleeve 204 to the sleeve expansion temperature for sleeve removal could stretch the carrier layer 240 to a condition short of its yield point such that the carrier layer 240 undergoes elastic deformation. For instance, if the operator does not intend to reuse the sleeve 204, the sleeve 204 could be heated to permanently stretch the carrier layer 240. However, if the sleeve 204 is to be reused after removal, the sleeve 204 is preferably not heated to the extent that the carrier layer 240 is permanently deformed.

It will be appreciated that other multilayer sleeves are within the ambit of the present invention. For some aspects of the present invention, it is not necessary that inner and engravable layers are cladded directly to one another or relative to one another, as shown in the two embodiments described above. For certain aspects of the present invention, it is just critical that the seam be defined and filler is used to bridge the gap in the outer layer.

Although the above description presents features of preferred embodiments of the present invention, other preferred embodiments may also be created in keeping with the principles of the invention. Such other preferred embodiments may, for instance, be provided with features drawn from one or more of the embodiments described above. Yet further, such other preferred embodiments may include features from multiple embodiments described above, particularly where such features are compatible for use together despite having been presented independently as part of separate embodiments in the above description.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A graphic arts sleeve comprising:
a multilayer curved plate presenting opposed end margins that cooperatively form a longitudinal seam,
said plate including an engravable layer and an inner layer cladded relative to one another, with the inner layer being located radially inward of the engravable layer;
an elongated slide extending along the seam and being fixed relative to the plate radially inward of the engravable layer; and
a filler located at least partly within the seam to bridge the end margins of the engravable layer,
said engravable layer and said filler cooperatively providing an outer sleeve surface, with at least part of the outer sleeve surface being continuous across the seam from one end margin to the other end margin.

2. The graphic arts sleeve as claimed in claim 1,
said plate presenting a substantially cylindrical shape to extend continuously between the end margins thereof.

3. The graphic arts sleeve as claimed in claim 2,
said outer sleeve surface being continuous.

4. The graphic arts sleeve as claimed in claim 1,
said engravable layer being clad directly to the inner layer.

5. The graphic arts sleeve as claimed in claim 4,
said engravable and inner layers being the only layers of the plate.

6. The graphic arts sleeve as claimed in claim 1,
said plate including an expansion layer cladded relative to the engravable and inner layers,
said expansion layer having a greater coefficient of thermal expansion than the inner layer.

7. The graphic arts sleeve as claimed in claim 6,
said inner layer being interposed between the engravable and expansion layers,
said engravable and expansion layers each being cladded to the inner layer.

8. The graphic arts sleeve as claimed in claim 7,
said engravable layer comprising copper,
said inner layer comprising stainless steel,
said expansion layer comprising an aluminum alloy.

9. The graphic arts sleeve as claimed in claim 7,
said engravable, inner, and expansion layers being the only layers of the plate.

10. The graphic arts sleeve as claimed in claim 7,
said inner layer being fixed directly to the slide.

11. The graphic arts sleeve as claimed in claim 10,
said slide being positioned radially inside the inner layer.

12. The graphic arts sleeve as claimed in claim 7,
said slide presenting a cross-sectional shape that tapers radially outwardly.

13. The graphic arts sleeve as claimed in claim 1,
said inner layer being fixed directly to the slide.

14. The graphic arts sleeve as claimed in claim 13,
said slide being positioned radially inside the inner layer.

15. The graphic arts sleeve as claimed in claim 14,
said slide spanning the seam.

16. The graphic arts sleeve as claimed in claim 1,
said slide presenting a cross-sectional shape that tapers radially outwardly.

17. A method of making a graphic arts sleeve, said method comprising the steps of:
(a) curving a multilayer plate so that end margins thereof are positioned adjacent one another to cooperatively form a longitudinal seam, wherein the plate includes an engravable layer and a radial inner layer cladded relative to one another;
(b) fixing the plate to a slide that extends along the seam radially inward of the engravable layer; and
(c) filling the seam at least partly with a filler material so that the engravable layer and the filler cooperatively provide an outer sleeve surface that is continuous across the seam from one end margin to the other end margin.

18. The method as claimed in claim 17; further comprising the step of:
(d) prior to step (a), cladding multiple layers to one another to form the multilayer plate.

19. The method as claimed in claim 17,
step (a) including the step of forming the plate into a substantially cylindrical shape.

20. The method as claimed in claim 17,
step (a) including the step of forming the seam so that the end margins cooperatively define a gap width dimension that ranges from about zero inches to about fifty thousandths of an inch.

21. The method as claimed in claim 17,
step (b) including the step of welding the end margins of the inner layer to the slide.

22. The method as claimed in claim 21; further comprising the step of:
(d) prior to step (b), removing endmost portions of the engravable layer to expose end margins of the inner layer.

23. The method as claimed in claim 21,
step (b) including the step of engaging the slide with an inner sleeve surface of the inner layer prior to welding.

24. The method as claimed in claim 21,
step (c) including the step of welding a bead of material to join the end margins of the engravable layer and thereby fill the seam.

25. The method as claimed in claim 24,
said bead of material including an excess portion that projects radially outwardly from the end margins of the engravable layer; and
(e) removing the excess part of the bead from the sleeve to produce a finished outer surface of the engravable layer, with the finished outer surface being continuous across the seam from one end margin to the other end margin.

26. The method as claimed in claim 25,
step (e) including the step of grinding the bead and the engravable layer to produce the finished outer surface.

27. The method as claimed in claim 25; further comprising the step of:
(f) engraving the finished outer surface of the engravable layer to form an engraved surface that defines image indicia.

28. The method as claimed in claim 27; further comprising the step of:
(g) applying a plated layer to the engraved surface.

29. The method as claimed in claim 17,
said bead of material including an excess portion that projects radially outwardly from the end margins of the engravable layer; and
(d) removing the excess part of the bead from the sleeve to produce a finished outer surface of the engravable layer, with the finished outer surface being continuous across the seam from one end margin to the other end margin.

30. The method as claimed in claim 29,
step (d) including the step of grinding the bead and the engravable layer to produce the finished outer surface.

31. The method as claimed in claim 29; further comprising the step of:
(e) engraving the finished outer surface of the engravable layer to form an engraved surface that defines image indicia.

32. The method as claimed in claim 31; further comprising the step of:
(f) applying a plated layer to the engraved surface.

33. An expandable press mandrel for removably supporting a graphic arts sleeve during press operations, said mandrel comprising:
a mandrel body having relatively shiftable body sections,
said mandrel body presenting an outer mounting surface operable to receive the sleeve,
said mounting surface defining an outermost dimension of the mandrel body, with relative shifting of the body sections varying the outermost dimension.

34. The expandable press mandrel as claimed in claim 33,
said mandrel body including a gap defined between the body sections, with relative shifting of the body sections causing the gap to expand or contract.

35. The expandable press mandrel as claimed in claim 34,
said mandrel body presenting opposite ends,
said gap extending between the ends and projecting radially inwardly relative to the mounting surface.

36. The expandable press mandrel as claimed in claim 35,
said mandrel body including a central tube passage,
said gap intersecting the tube passage.

37. The expandable press mandrel as claimed in claim 36,
said gap and said tube passage extending from one end of the mandrel body to the other.

38. The expandable press mandrel as claimed in claim 35,
said mandrel body defining a slot that projects inwardly from the mounting surface,
said slot being configured to slidably receive a portion of the sleeve therein.

39. The expandable press mandrel as claimed in claim 38,
said gap intersecting the slot.

40. The expandable press mandrel as claimed in claim 35,
said mounting surface being cylindrical in shape, such that the outermost dimension is a body diameter that varies when the body sections are shifted relative to one another.

41. The expandable press mandrel as claimed in claim 33,
said body sections being integrally formed such that the mandrel body is unitary, with the mandrel body being flexible to permit relative shifting of the body sections.

42. The expandable press mandrel as claimed in claim 41, further comprising:
a clamp removably attached to the body sections and adjustable to apply a radially inward clamping force to the body sections to flex the mandrel body and thereby contract the outermost dimension of the mandrel body.

43. The expandable press mandrel as claimed in claim 42,
said clamp being spaced radially inwardly of the outer mounting surface to permit mounting and removal of the sleeve relative to the outer mounting surface.

44. The expandable press mandrel as claimed in claim 42,
said body sections of the mandrel body cooperatively defining a slot that projects inwardly from the mounting surface,
said slot being configured to slidably receive a portion of the sleeve therein, with shifting of the body sections by the clamp changing the size of the slot.

45. The expandable press mandrel as claimed in claim 33, further comprising:
a shifting device removably attached to the body sections and operable to move the body sections toward each other to contract the outermost dimension of the mandrel body.

46. The expandable press mandrel as claimed in claim 45,
said shifting device moving the body sections radially inwardly at the same time when contracting the mandrel body.
